(19) United States
(12) Patent Application Publication
(10) Pub. No.: US 2020/0128233 A1
(43) Pub. Date: Apr. 23, 2020

(54) MOBILE DEVICE

(71) Applicant: Red Technologies, LLC, Irvine, CA (US)

(72) Inventors: James H. Jannard, Las Vegas, NV (US); Peter Jarred Land, Los Angeles, CA (US); Wassym Bensaid, Cupertino, CA (US); Ziad Mansour, San Jose, CA (US)

(21) Appl. No.: 16/595,972

(22) Filed: Oct. 8, 2019

Related U.S. Application Data
(63) Continuation-in-part of application No. 16/286,293, filed on Feb. 26, 2019.
(60) Provisional application No. 62/746,998, filed on Oct. 17, 2018.

(51) Int. Cl. H04N 13/398; G03B 35/12; H04N 13/239; H04N 13/356; H04N 13/189; H04S 7/00; H04R 5/02; H04M 1/02

(52) U.S. Cl. CPC H04N 13/398; G03B 35/12; H04N 13/239; H04M 1/0264; H04N 13/189; H04S 7/30; H04R 5/02; H04N 13/356

(57) ABSTRACT

A mobile device is provided comprising a housing, at least two cameras supported by the housing and arranged to capture image data and a multi-view display. The multi-view display may be a lightfield display and may comprise a diffractive lightfield backlighting system. The multi-view display may be configured to display multi-view video derived from image data captured by the at least two cameras and optionally operate in at least one of a multi-view mode or a multi-dimensional display mode.

### CROSS-REFERENCE TO RELATED APPLICATION

This application claims priority to and the benefit of the earlier filing date of U.S. Provisional Application 62/746,998, filed on Oct. 17, 2018 and U.S. application Ser. No. 16/286,293, filed on Feb. 26, 2019 the contents of which are incorporated by references herein in entirety.

### TECHNICAL FIELD

The disclosed subject matter generally relates to mobile devices and, more particularly, to an expandable mobile communication device with enhance audio and imaging capabilities.

### BACKGROUND

Demand for mobile devices with high-end media capture capability continues to advance. Creators of professional video and audio recordings, as well as increasingly large numbers of consumers are demanding high quality video and audio recording and playback capability in mobile computing devices including cellphones/smart phones, tablets, and the like.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with some implementations of the disclosed subject matter, a mobile device is provided. The mobile device comprises a housing; at least two cameras supported by the housing and arranged to capture image data; and a multi-view display. The multi-view display may be a lightfield display and comprise a diffractive lightfield backlighting system. The multi-view display is configured to display multi-view video derived from image data captured by the at least two cameras and optionally operate in at least one of a multi-view mode or a multi-dimensional display mode.

The multi-dimensional display mode may have a two-dimensional display mode and a three-dimensional display mode. In some embodiments, the at least two cameras are configured to capture stereoscopic image data. The multi-view display is configurable to operate in a playback mode to play multi-view video previously recorded, and optionally operate as a viewfinder to present multi-view video in real time. The mobile device may comprise a module connector for connecting at least a first functional module to the mobile device to enhance image capture or display functionalities of the mobile device, depending on implementation.

In certain embodiments, a mobile device may be implemented to include a housing; at least two cameras supported by the housing and arranged to capture image data; and a processor for processing one or more audio spatialization profiles. The processor may be configured to apply at least one spatialization profile of the one or more spatialization profiles to an audio signal to generate a spatialized audio signal. The spatialization profile may include one or more impulse responses. In one embodiment, the processor is configured to convolve the audio signal with the one or more impulse responses to generate the spatialized audio signal. Application of the spatialization profile to the audio signal results in one or both of a directional audio effect or an externalization audio effect when the spatialized audio signal is played.

At least two integrated speakers configured to output the spatialized audio signal may be included in the mobile device. The processor may apply the spatialization profile when the mobile device is in a landscape orientation. In one embodiment, the processor fails to apply the spatialization profile when the mobile device is in a portrait orientation. At least two integrated speakers may be included such that a first integrated speaker is positioned on a top half of the housing and a second integrated speaker is positioned on a bottom half of the housing. The first speaker and the second speaker may be positioned substantially symmetrically with respect to one another on opposing sides of a transverse axis of the mobile device.

In accordance with alternate embodiments, the mobile device may comprise one or more of a housing, at least two cameras supported by the housing and arranged to capture image data, a multi-view display comprising diffractive lightfield backlighting system configured to display multi-view video derived from image data captured by the at least two cameras, and a processor for processing one or more audio spatialization profiles to generate multi-dimensional audio by way of, for example, applying at least one spatialization profile of the one or more spatialization profiles to an audio signal to generate a spatialized audio signal, wherein the spatialization profile comprises one or more impulse responses.

The multi-view display may be configured to operate in at least one of a multi-view mode or a multi-dimensional display mode comprising a two-dimensional display mode and a three-dimensional display mode, such that the processor convolves the audio signal with the one or more impulse responses to generate the spatialized audio signal. Application of the spatialization profile to the audio signal results in one or both of a directional audio effect or an externalization audio effect when the spatialized audio signal is played. The at least two cameras may be configured to capture stereoscopic image data and at least two integrated speakers are configured to output the spatialized audio signal.

A module connector may be provided for connecting one or more functional modules attachable to the housing, a functional module configured for enhancing one of video or audio functionalities of the mobile device. The module connector may comprise data communication bus contacts corresponding to at least a first data bus and a second data bus, wherein the bus contacts for the first data bus are adjacent to either a ground pin or another bus contact for the first data bus and each of the bus contacts for the second data bus are adjacent either to a ground contact or to another contact corresponding to the second data bus.

In some embodiments, the module connector comprises a module identifier contact, the mobile device further comprising circuitry configured, when the module identifier contact is coupled to a corresponding contact of a module attached to the mobile device, to detect a value of a resistor connected to the corresponding contact. The mobile device may comprise a camera module attachable to the housing of the mobile device via the module connector. The camera module may comprise a battery which, when the camera module and the housing of the mobile device are attached, powers electronics within the mobile device; and an image processing componentry configured to generate compressed raw video data.

The details of one or more variations of the subject matter described herein are set forth in the accompanying drawings and the description below. Other features and advantages of the subject matter described herein will be apparent from the description and drawings, and from the claims. The disclosed subject matter is not, however, limited to any particular embodiment disclosed.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations as provided below.

FIG. 1A illustrates a top, front, left-side perspective view of an example mobile device, in accordance with one or more embodiments.

FIG. 1B illustrates a bottom, rear, right-side perspective view of the mobile device of FIG. 1A.

FIG. 2 is a schematic diagram of a system including a mobile device and one or more modules configured to operate with the mobile device, in accordance with one or more embodiments.

FIG. 3 is a schematic diagram illustrating various modular configurations, in accordance with one or more embodiments.

FIG. 4A illustrates a side view of a mobile device positioned for attachment to an example camera module, in accordance with one or more embodiments.

FIG. 4B illustrates a perspective view of the mobile device and the camera module of FIG. 4A when attached.

FIG. 4C illustrates a side view of a mobile device positioned for attachment to an example battery module, in accordance with one or more embodiments.

FIG. 4D illustrates a perspective view of the mobile device and the battery module of FIG. 4C when attached.

FIG. 4E illustrates a side view of a mobile device positioned for attachment to an example expander module, in accordance with one or more embodiments.

FIG. 4F illustrates a perspective view of the mobile device of FIG. 4E and the expander module of FIG. 4E when attached.

FIG. 4G illustrates a perspective view of a mobile device positioned for attachment to the expander module and camera module, in accordance with one or more embodiments.

FIG. 4H illustrates a perspective view of the mobile device, the expander module, and the camera module of FIG. 4H when attached.

FIGS. 5A and 5B show examples of module connectors, in accordance with one or more embodiments.

FIG. 5C shows a schematic diagram of a camera module connected to a mobile device via a plurality of bus interfaces, in accordance with one or more embodiments.

FIG. 6A illustrates a perspective view of a mobile device multi-view display, according to certain embodiments.

FIG. 6B illustrates angular components of a light beam having a particular principal angular direction corresponding to a view direction of a mobile device multi-view display, according to certain embodiments.

FIG. 7 illustrates a cross sectional view of a diffraction grating for a multi-view display of a mobile device, according to certain embodiments.

FIG. 8A illustrates a cross sectional view of an example of a diffractive backlight of a multi-view display, according to certain embodiments.

FIG. 8B illustrates a plan view of an example of a diffractive backlight of a multi-view display, according to certain embodiments.

FIG. 8C illustrates a perspective view of a diffractive backlight of a multi-view display, according to certain embodiments.

FIG. 9 schematically illustrates a directional backlight of a multi-view display in accordance with various embodiments.

FIGS. 10A and 10B illustrate example top views of a directional backlight of a multi-view display of FIG. 9.

FIG. 11 is a flowchart of a method for generating a 3D image with a directional backlight of a multi-view display in a mobile device in accordance with example embodiments.

FIGS. 12A-12D illustrate examples of various components, such as speaker and microphone arrangements, for mobile devices according to certain embodiments.

FIGS. 13A and 13B illustrate components of an example of an image capture device, which may be implemented in any of the camera modules or mobile devices described herein.

FIG. 14 illustrates an example method for processing image data that is performable by an image capture device, such as the image capture device of FIG. 13A.

FIG. 15 is a plot illustrating an example pre-emphasis function.

FIG. 16 illustrates an example process for compressing video image data that is performable by an image capture device, such as the image capture device of FIG. 13A.

FIG. 17 illustrates example mobile device electronic and computing components in accordance with certain embodiments.

The figures may not be to scale in absolute or comparative terms and are intended to be exemplary. The relative placement of features and elements may have been modified for the purpose of illustrative clarity. Where practical, the same or similar reference numbers denote the same or similar or equivalent structures, features, aspects, or elements, in accordance with one or more embodiments.

### DETAILED DESCRIPTION

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

Although the electronic devices described herein may be primarily described in the context of a smart phone, the disclosures are applicable to any of a variety of electronic devices with or without cellphone functionality, including tablets, digital still and motion cameras, personal navigation devices, mobile internet devices, handheld game consoles, or devices having any or a combination of these functions or other functions.

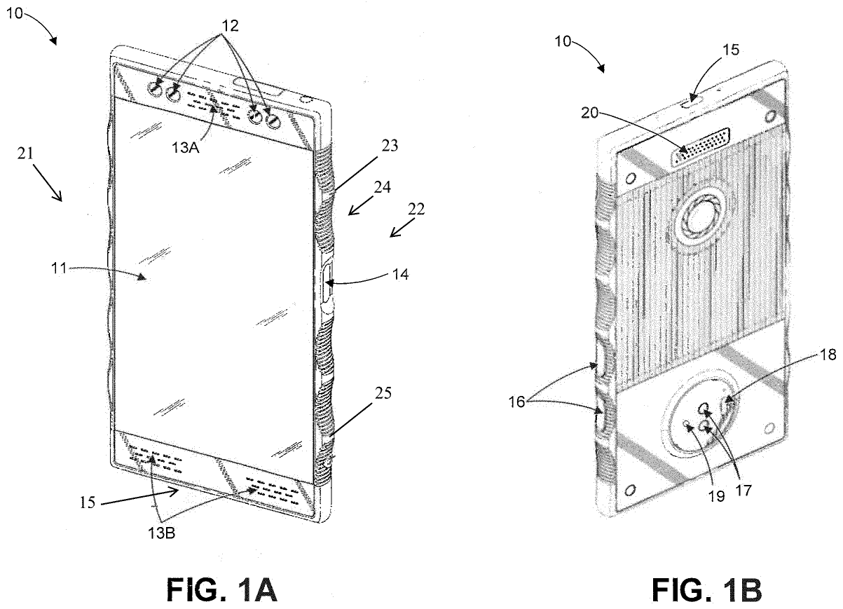

FIG. 1A illustrates a top, front, left-side perspective view of a phone 10 that may implement any of the multi-view display, sound surround spatialization, video processing, or other functions described herein. The phone 10 may be a smart phone. The front of the phone 10 includes a display 11, cameras 12 (e.g., one, two or multiple cameras) a first speaker grill 13A covering a first speaker, and second speaker grills 13B, which may cover one, two or more additional speakers. The phone 10 may include also include one or more microphones (not shown). One side (e.g., the left side) of the phone 10 includes a first input 14, which may be a fingerprint reader. A record button 25 may be also included.

FIG. 1B illustrates a bottom, rear, right-side perspective view of the phone 10. The bottom of the phone includes a power input port 15. The left side of the phone 10 includes second inputs 16, which may be control buttons. The back of the phone 10 includes second cameras 17 (for instance, two cameras as illustrated), a flash 18, a laser focus 19, and a module connector 20. The display 11 may display a variety of applications, functions, and information and may also incorporate touch screen control features. For instance, the display 11 may be any of the multi-view displays described herein.

At least one or both of the first cameras 12 and the second cameras 17 includes a capability for capturing video image data frames with various or adjustable resolutions and aspect ratios as described herein. The first cameras 12 may generally face the same direction as one another, and the second cameras 17 may generally face the same direction as one another. In one embodiment, there is one front-facing camera. The second rear facing cameras 17 in may capture stereoscopic image data, which may be used to generate multi-view content for presentation on the display 11.

The first input 14 and the second inputs 16 may be buttons and receive user inputs from a user of the phone 10. The first input 14 can, for example, function as a power button for the phone 10 and enable the user to control whether the phone 10 is turned on or off. Moreover, the first input 14 may serve as a user identification sensor, such as a finger print sensor, that enables the phone 10 to determine whether the user is authorized to access the phone 10 or one or more features of or files stored on the phone 10 or a device coupled to the phone 10. The first input 14 may function as a device lock/unlock button, a button to initiate taking a picture, a button to initiate taking of a video, or select button for the phone 10. The second inputs 16 may function as a volume up button and a volume down button for the phone 10. The functionality of the first input 14 and the second inputs 16 may be configured and varied by the user.

As shown, the left and right sides 21, 22, of the phone 10 may include scallops/concavities 24 and/or ribs/serrations to facilitate gripping the phone 10, as described in U.S. Pat. No. 9,917,935; the entire disclosure of which is included in the Appendix incorporated herein by reference. In particular, each side 21, 22 of the phone 10 includes four concavities 24 defined by five projections 23. The concavities 24 are equally spaced with two per side 21, 22 on the top half of the housing of the phone 10 and two per side 21, 22 on the bottom half of the housing of the phone 10. The concavities in one implementation are centered on one-inch intervals.

Notably, the concavity 24 in which the first input 14 is positioned may not include serrations, while the other concavities may include serrations, which may assist a user with distinguishing the two edges of the phone 10 from one another, as well as the first input 14 from the second inputs 16. The phone 10 may receive no user inputs to the front of the phone 10 except via the display 11, in some embodiments. The front of the phone 10 thus may include no buttons, and any buttons may be located on one or more sides of the phone 10. Advantageously, such a configuration can, in certain embodiments, improve the ergonomics of the phone 10 (such as by enabling a user to not have to reach down to a front button) and increase an amount of space available for the display 11 on the phone 10.

The module connector 20 may interchangeably couple with a module and receive power or data from or transmit power or data to the module or one or more other devices coupled to the module. The module may include a camera, a display, a video game controller, a speaker, a battery, an input/output expander, a light, a lens, a projector, and combinations of the same and the like. The module moreover may be stacked to one or more other module to form a series of connected modules coupled to the phone 10, such as described in U.S. Patent Application Publication No. 2017/0171371; the entire disclosure of which is included in the Appendix and incorporated herein by reference.

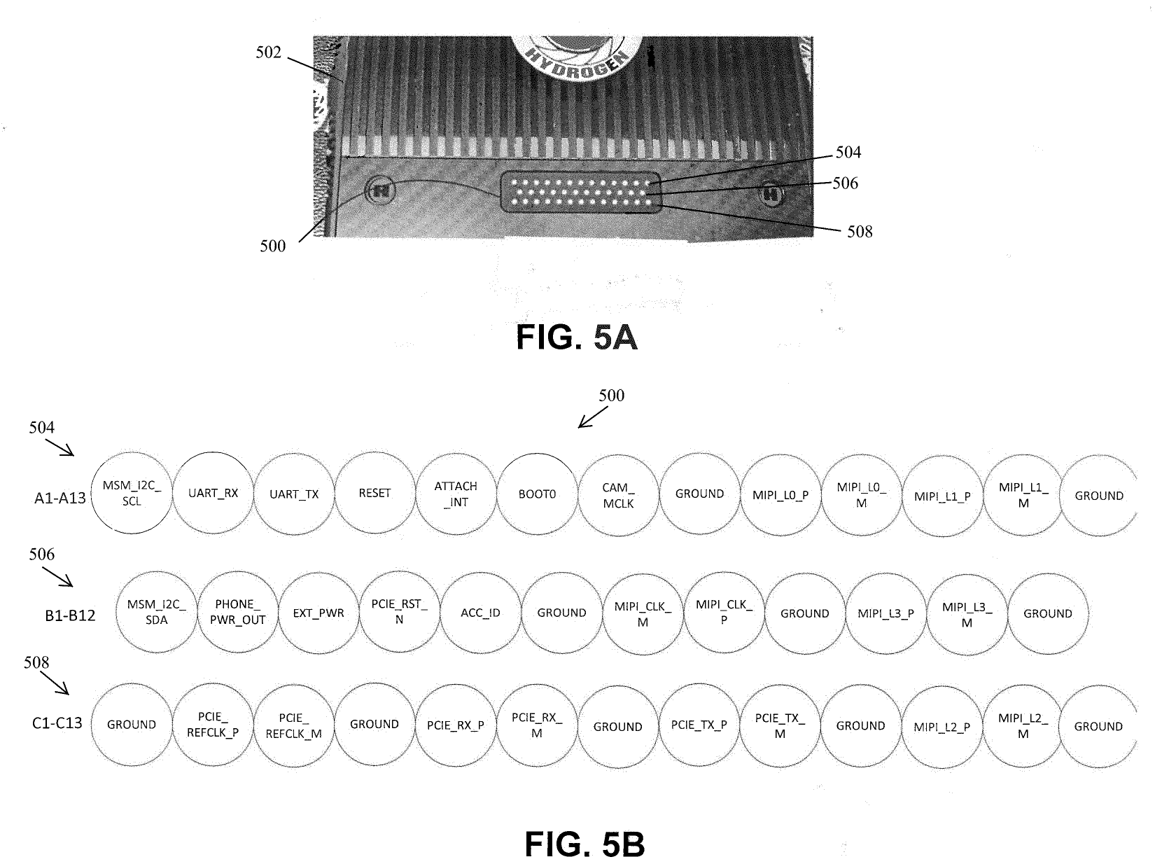

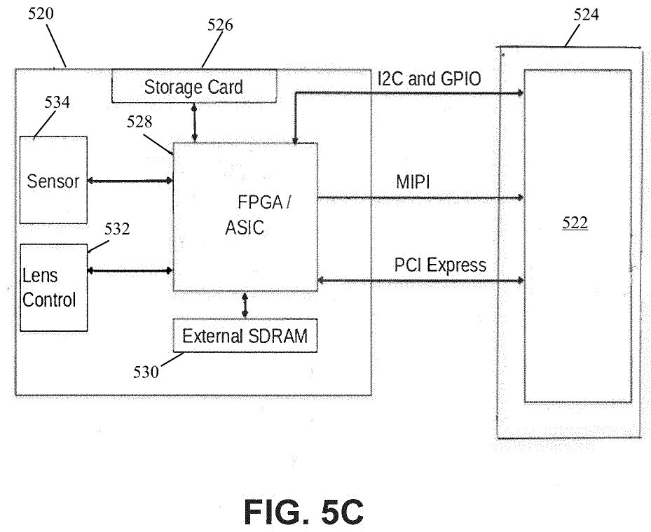

The module connector 20 may include multiple contacts (e.g., 38 contacts in three rows as shown in FIGS. 5A-5B, or 44 contacts in three rows, or 13 contacts in one row, among other possibilities) that engage with contacts on a corresponding connector of a module to electronically communicate data. The multiple contacts may engage with a spring-loaded connector or contacts of the module. In some implementations, the phone 10 may magnetically attach to or support the module, and the phone 10 and the module may each include magnets that cause the phone 10 to be attracted and securely couple. The phone 10 and the module may further be coupled in part via a friction fit, interlocking structures, fasteners, mechanical snap surface structures, mechanical latch surface structures, mechanical interference fit surface structures, or the like between one or more portions of the phone 10 and one or more portions of the module.

Additional information about coupling of and communicating data between a device and one or more modules may be found in U.S. Patent App. Pub. Nos. 2017/0171371 and U.S. Pat. Nos. 9,917,935 and 9,568,808; the disclosures of which are included in the Appendix and herein incorporated by reference in their entirety.

The dimensions of the phone 10 may vary depending on the particular embodiment. For example, the phone 10 may be approximately 100 mm high by 50 mm wide by 15 mm thick. In another example, the phone 10 may be about 150 mm in height, 70 mm wide and 10 mm thick. In yet another example, the phone 10 may be about 130 mm high, by 70 mm wide by 10 mm thick. In yet a further example, the phone 10 may be approximately 120 mm high by 60 mm wide by 10 mm thick. The display 11, for instance, may be a 4″, 4.5″, 5″, 5.5″, 5.7″, 6″, 6.5″, 7″, or 7.5″ display.

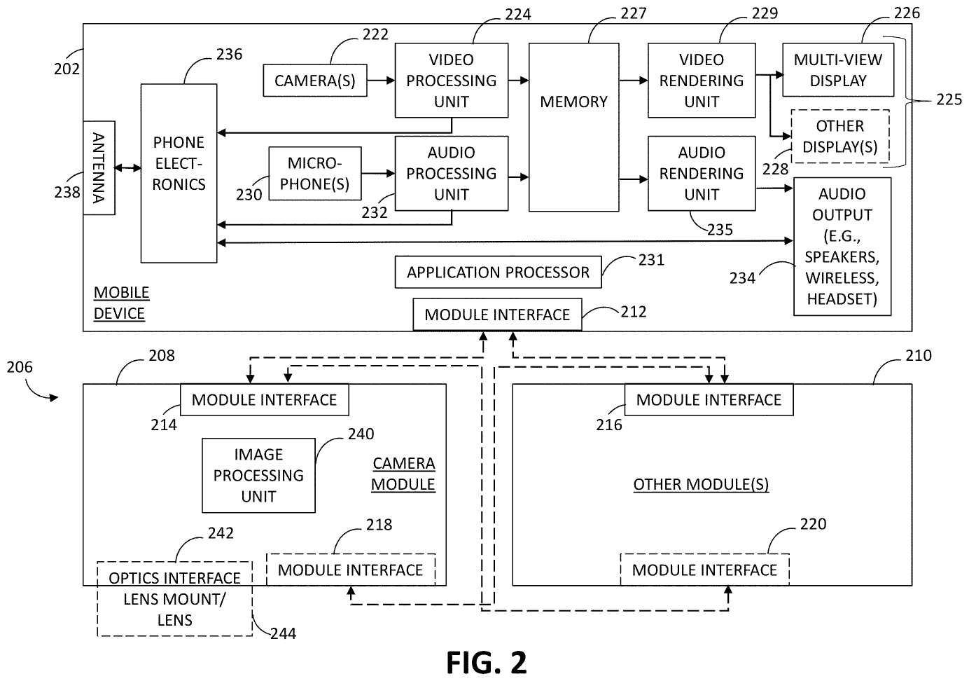

FIG. 2 is a schematic diagram of a system 200 including a mobile device 202 and one or more modules 206. The illustrated modules 206 include a camera module 208 and one or more additional modules 210 configured to operate with the mobile device 202. The mobile device 202 may be any of the phones, tablets or other mobile devices described herein, such as the phone 10, the phone 100, or another mobile device. The camera module 208 may be any of the camera modules described herein, such as the camera module 30, image capture device 50, or another camera module. The additional modules 210 may be any of the other modules described herein, such as the modules 60-67, the battery module 800, the expander module 900.

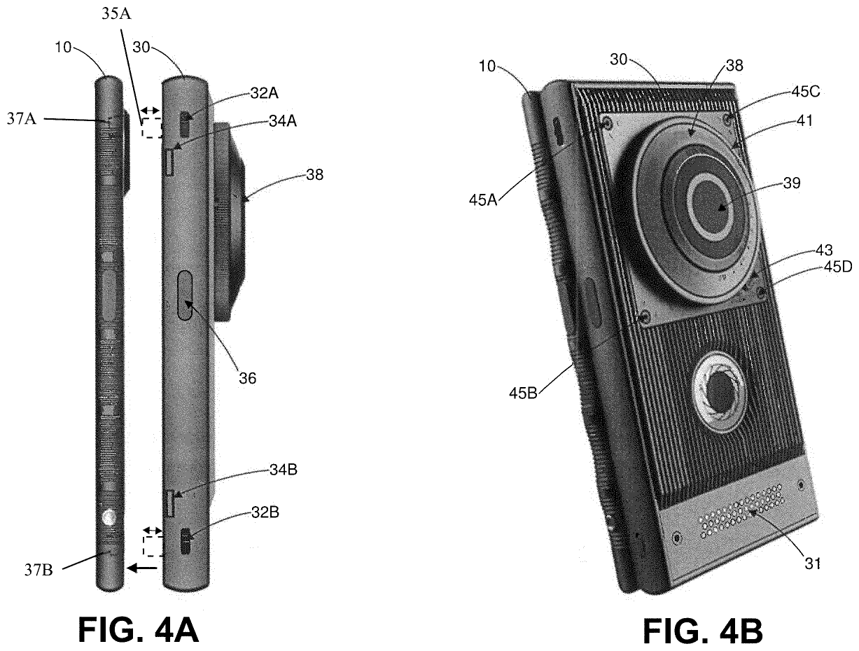

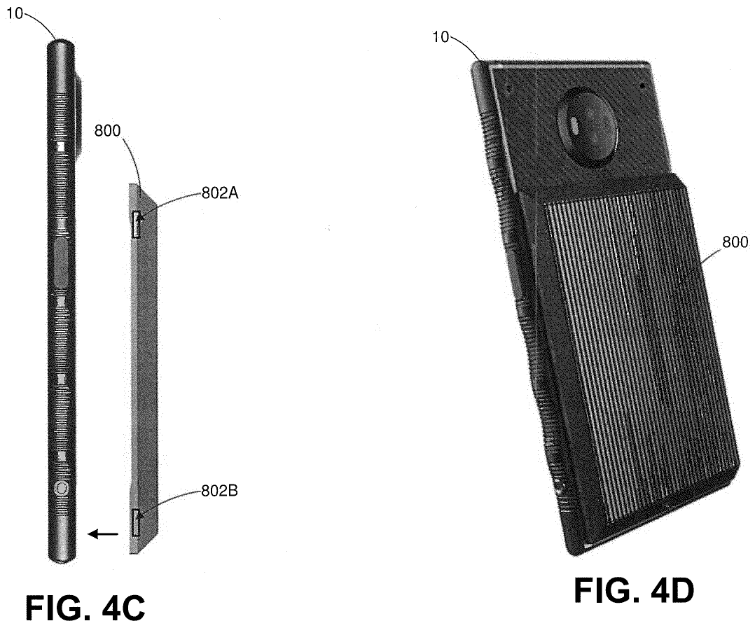

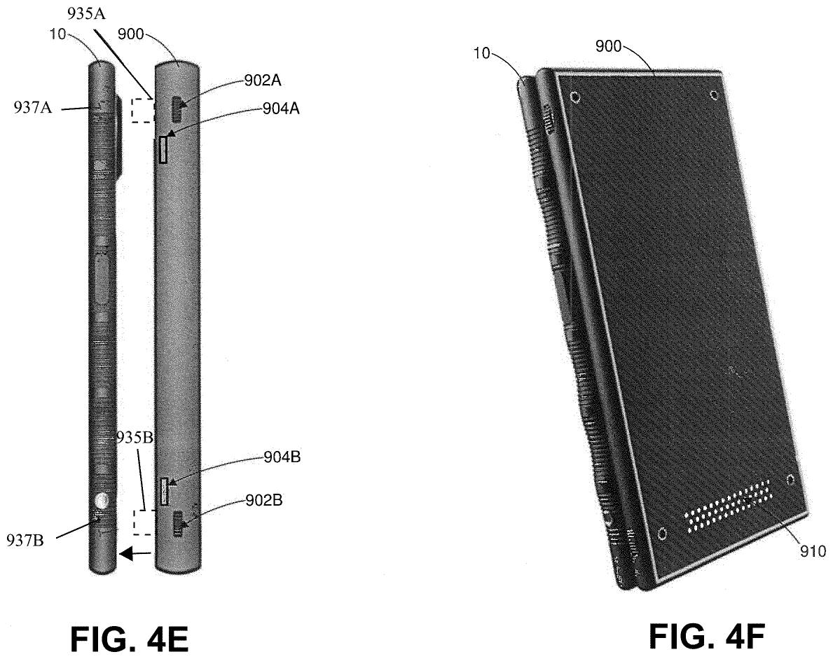

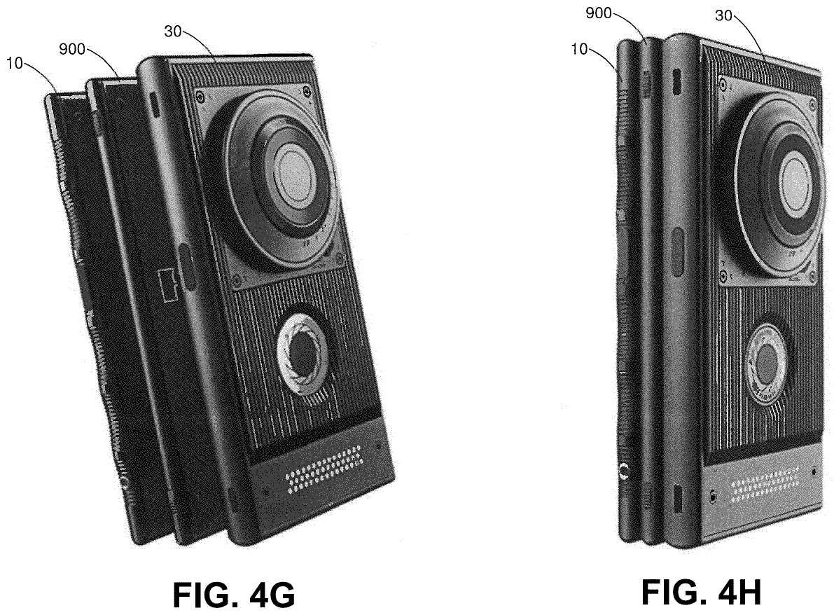

The mobile device 202 includes a module interface 212 that is configured for connection to a corresponding module interface 214 of the camera module 208 and/or the module interface 216 of the other module(s) 216. For instance, the module interface 212 may be the connector 20 of the phone 10, the connector 500 of FIGS. 5A-5B, or another connector. The camera module 208 may include an additional module interface 218 configured for connection to any of the other module(s) 210. The additional module interface 218 may be positioned on an opposite side of the housing of the camera module 208 from the module interface 214. For example, in one embodiment, the additional module interface 218 is the connector 31 (e.g., FIG. 4B) of the camera module 30, which may connect to the module interface 216 of another module 210 (e.g., a battery module).

The battery module 800 may be utilized to power the phone 10, but can also power the camera module 30. The camera module 30 can be attached to the phone 10 directly, or through the battery module 800, depending on implementation. The camera module 30 may be a single high-resolution camera that captures 2D images and videos, or a dual camera module that captures four view (4V) images and videos that can be displayed or streamed on the phone 10.

In certain embodiments, 4V images may be captured by the phone 10 or the camera module 30. The 4V captured images may be viewable as 3D images or videos when displayed on the phone 10. One or more 4V images may include special metadata, which allow the images to be displayed as 4V, when the images are shared with other phones or displays that support 4V technology. In a 2D mode or in displays that do not support 4V, the images may be displayed as 2D without any additional processing.

The other module(s) 210 may also include an additional module interface 220, which may be positioned on an opposite side of the housing of the other module(s) 210 from the module interface 216. For instance, in one embodiment the other module(s) 210 include the extender module 900 (FIG. 4E-4F), where the module interface 216 is the connector that attaches to the phone 10, and the additional module interface 220 is the connector 910. The additional module interface 220 of the other module(s) 220 may be configured for connection to the module interface 214 of the camera module 208, such that one or more of the other module(s) 210 may be positioned between the mobile device 202 and the camera module 208. Such a configuration is shown in FIGS. 4G-4H, for example, where the extender module 900 is positioned between the camera module 30 and the phone 10.

Depending on implementation, the module interfaces 212, 218, 220 may have a common orientation as each being male or each being female interfaces, while the interfaces 214, 216 may have the other orientation. For instance, the interfaces 212, 218, 220 may be male-oriented, and the interfaces 214, 216 may be female-oriented, or vice versa. In this manner, the camera module 208 and/or other module(s) 210 may generally be stacked onto one another in any order to form a stack of modules. The interfaces may comprises spring-loaded contacts (e.g., pogo pins) in some embodiments. For example, the interfaces 212, 218, 220 in one implementation comprise spring-loaded contacts, which, when brought together with fixed contacts of the interfaces 214, 216, create a robust connection. In another implementation the interfaces 214, 216 include the spring-loaded contacts, while the interfaces 212, 218, 220 comprises fixed contacts.

The mobile device 202 may additionally include one or more cameras 222, a video processing unit 224, a memory 227, a video rendering unit 229, one or more displays 225, which may include a multi-view display 226 and one or more other displays 228 (e.g., a 2D display), one or more microphones 230, an application processor 231, an audio processing unit 232, an audio rendering unit 235, one or more audio outputs 234, phone electronics 236, and an antenna 238. Although not shown, the mobile device 202 may additionally include a battery configured to power the mobile device 202. In some cases, the mobile device 202 may deliver power to one or more of the modules 206 for powering electronics within the modules 206.

The phone electronics 236 may include software and hardware for implementing mobile telephony functionality, and may include a baseband processor, transceiver, radio frequency front-end module and the like, which may operate according to one or more communication protocols (e.g., one or more of LTE, 4G, 5G, WiFi, and Bluetooth). The phone electronics 238 generally processes data wirelessly received by the antenna 238, and processes data for transmission prior to providing it to the antenna 238. The application processor 231 may be a microprocessor designed for mobile use, with relatively long battery life and enhanced audio and video processing capabilities. In some embodiments, the application processor 231 implements one or more of the other components of the mobile device 202, such as one or more of the video processing unit 224, audio processing unit 232, video rendering unit 229, and audio rendering unit 235. In other implementations, the mobile device 202 includes one or more additional processors that implement some or all of these components.

The application processor 231 may be connected the module interface 212 to communicate with the modules 206. Although not explicitly shown in FIG. 2, the application processor 231 may also be connected to any of the various components on the mobile device 202. As one example, the application processor 231 may receive video data from the camera module 208, and forward the video data to one or more of the memory 227 (e.g., for storage), to the video rendering unit 229 or display 225 (e.g., for viewfinder display during recording), or to the video processing unit (e.g., for compression and/or other processing). The cameras 222 may include one or multiple front facing cameras (e.g., the cameras 12 of the phone 10) and one or multiple rear facing cameras (e.g., the cameras 17 of the phone 10).

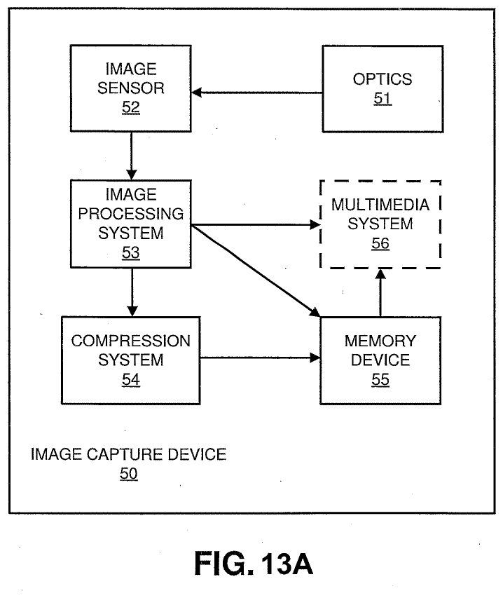

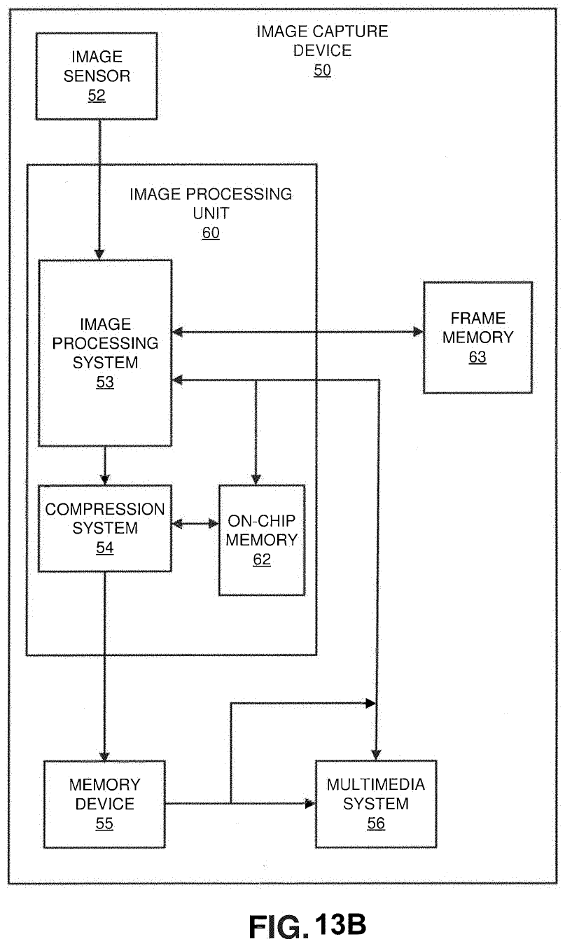

The cameras 222 may output recorded video or still image data to the video processing unit 224, which may incorporate any of the video processing techniques described herein. For instance, the video processing unit 224 may implement the compressed raw video processing described with respect to FIGS. 13A-16 on video recorded by the cameras 222, or some other image processing and/or compression techniques. Where the cameras 222 capture 3D footage, such as where the cameras 17 respectively capture left and right eye stereoscopic footage, the video processing unit 224 may perform appropriate processing on the 3D footage for display on the multi-view display 226. The video processing unit 224 outputs a stream of processed video, which may be stored in a file in the memory 227 for later playback.

In some embodiments, the mobile device 202 includes a video rendering 229 unit configured to access recorded footage from the memory 227 and render footage for display. For instance, the video rendering unit 229 may render 3D or multi-view footage for display by the multi-view display 226. In other embodiments, the video processing unit 224 may perform such rendering before storage in the memory 227. In some embodiments, the mobile device 202 may provide real time recording and viewing. In such cases, the video processing unit 224 and/or rendering unit 229 process and/or renders the footage as appropriate, and stream it to the multi-view display 226 or to the phone electronics (e.g., for wireless transmission via the antenna 238), without first storing it in the memory 227.

The camera module 208 may also include an optics interface 242 configured to releasably accommodate a lens mount or lens 244, such as the lens mount 41 of the camera module 30 of FIGS. 4A-4B. In another embodiment, the camera module 208 has a fixed integrated lens.

While in the illustrated embodiments of the phones and mobile device 202 provided herein include integrated, fixed lenses, in some other embodiments, the mobile device 202 has an optics interface for may releasably accommodating one or more lenses or lens mounts, for use with the camera(s) 222. Although not shown, the camera module 208 may additionally include a battery, which may power the camera module 208. In one embodiment, the camera module 208 may deliver power to the mobile device 202 via the connection between the module interface 214 of the camera module 208 and the module interface 212 of the mobile device 202. The power delivered from the camera module 208 may be sufficient to fully power both the camera module 208 and the mobile device 202 in some embodiments. The other module(s) may include appropriate electronics or other components to implement any of the modules described herein, or some other module.

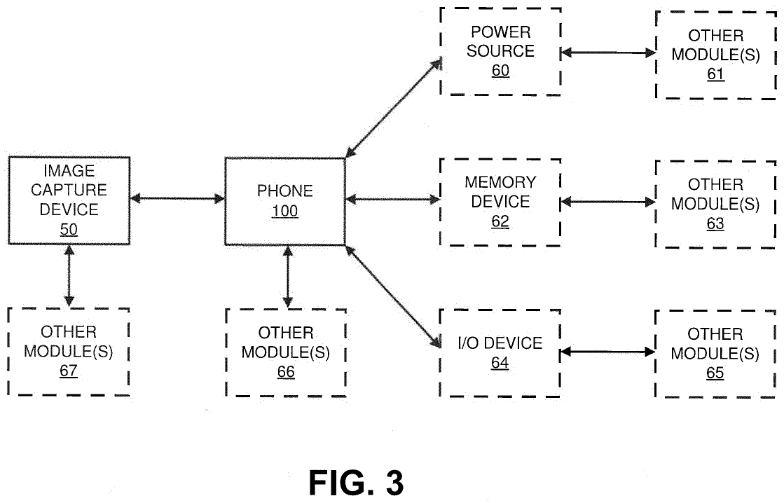

FIG. 3 illustrates the image capture device 50 in communication with a phone 100. The image capture device 50 can, for example, be an embodiment of the camera module 30, and the phone 100 can, for example, be an embodiment of the phone 10. The phone 100 may be modular and couple to one or more modules as described herein. For example, the phone may mechanically or electrically connect to a power source 60, a memory device 62, or an input/output (I/O) device 64, as well as the image capture device 50 or one or more other modules 66. In addition, the phone 100 may electrically communicate with one or more other modules 61, 63, 65, 67 respectively through the power source 60, the memory device 62, the input/output (I/O) device 64, and the image capture device 50, and the one or more other modules 61, 63, 65, 67 may respectively couple to the power source 60, the memory device 62, the input/output (I/O) device 64, and the image capture device 50. Embodiments and features of modular phones and camera modules are further described in U.S. Patent Application Publication No. 2017/0171371; the entire disclosure of which is included in the Appendix and incorporated herein by reference.

FIG. 4A illustrates a side view of the phone 10 positioned for attachment to a camera module 30, and FIG. 4B illustrates a perspective view of the phone 10 and the camera module 30 when attached. The camera module 30, alone or in combination with the phone 10, may implement one or more of the compression techniques or other features described herein. The camera module 30 may include a housing that supports magnets 34A and 34B and an input 36, which may be a button, and one or more fastener controls 32A, 32B for controlling one or more fastening elements 35A, 35B. The magnets 34A and 34B may facilitate coupling of the housing to the phone 10. For example, the magnets 34A, 34B may magnetically attract to one or more corresponding magnets or magnetic material in the housing of the phone 10 (not shown), thereby fastening the phone 10 and camera module 30 to one another.

The camera module 30 and phone 10 may also fasten to one another via one or more fastening elements 35A, 35B, which may be threaded screws in some embodiments. When a user turns the wheels 32A, 32B, the screws 35A, 35B are moved between fully extended and fully retracted positions with respect to the housing of the camera module 30. When moved to the extended position the screws 35A, 35B mate with corresponding holes having female threading in the housing of the phone 10, thereby allowing for threaded mating of the 10 and camera module 30. While two screws 35A, 35B, holes 37A, 37B, and wheels 32A, 32B are shown in FIGS. 4A and 4B, there may be 1, 3, 4 or more screws and corresponding holes and wheels depending on the embodiment. In other embodiments, the fastening elements 35A, 35B and corresponding holes 37A, 37B are not threaded and fit together via magnetic connection, friction fit, or other appropriate mechanism.

Any of the other modules described herein may similarly fasten to the phone 10 or to any of the other modules via similar magnets 34A, 34B and/or fastening elements 35A, 35B. For instance, in some embodiments, both the screws and magnets are used to provide robust fastening between the phone 10 and the camera module 30 and other relatively heavy modules, while only the magnets are used for lighter modules. The input 36 may be used to receive user inputs to the camera module 30 to control activities of the camera module 30 like changing of a mode or initiating capture of video. Although not illustrated in FIGS. 4A and 4B, the camera module 30 may also include magnets on an opposite side of the housing of the camera module 30 from the side shown in FIG. 4A to couple the opposite side to the housing of the phone 10.

The camera module 30 may further couple to an optical module 38 that may be interchangeable with one or more other optical modules. The optical module 38 can, for example, include one or more optical elements such as lenses, shutters, prisms, mirrors, irises, or the like to form an image of an object at a targeted location. Embodiments of camera modules and optical modules and approaches for coupling the camera modules and optical modules are further described in U.S. Patent Application Publication No. 2017/0171371; the entire disclosure of which is included in the Appendix and incorporated herein by reference.

The optical module 38 may include a removable lens 39 and a lens mount 41, where the lens 39 may be inserted into an opening (not shown) of the lens mount 41, and then rotated to secure the lens in place. In one embodiment, the lens mount 41 may include a button 43 or other type of control, allowing for removal of the lens 39. For instance, the user may push or otherwise interact with the button 43 which allows the user to rotate the lens 39 in the opposite direction and remove the lens 39 from the opening of the lens mount 41. In some embodiments, the lens mount 41 itself is removable and re-attachable via holes 45A, 45B, 45C, 45D, for example, by inserting a mounting screw through each hole. The lens mount 41 or the lens 39 can, for example, be one of those described in U.S. Pat. No. 9,568,808, which is included in the Appendix and hereby incorporated by reference in its entirety.

The camera module 30 may include a module connector 31, similar to or the same as the module connector 20, that may interchangeably couple with an additional module (for example, engage with contacts on a corresponding connector of the additional module) and receive power or data from or transmit power or data to the module or one or more other devices coupled to the module. The additional module may include a camera, a display, a video game controller, a speaker, a battery, an input/output expander, a light, a lens, a projector, one or more microphones, or combinations of the same and the like. In one example, the additional module connected to the module connector 31 may be an input/output expander and include one or more additional inputs that enable a user to control operations of the camera module 30.

The additional module moreover may have a form factor that permits coupling of a corresponding connector of the additional module to the module connector 31 without the additional module impeding placement or use of the lens mount 41 or obstructing a view through the lens 39 from an image sensor in the camera module 30 (for example, the additional module may not cover the entire surface of the camera module 30 that includes the module connector 31). In some implementations, the additional module may magnetically attach to or be supported by the camera module, and the additional module and the camera module 30 may each include magnets that cause the two to be attracted and securely couple. Additionally or alternatively, coupling may be achieved at least via a friction fit, interlocking structures, fasteners, mechanical snap surface structures, mechanical latch surface structures, mechanical interference fit surface structures, or the like.

FIG. 4C illustrates a side view of the phone 10 positioned for attachment to a battery module 800, and FIG. 4D illustrates a perspective view of the phone 10 and the battery module 800 when attached. The battery module 800 may include a housing that supports magnets 802A and 802B for coupling the battery module to the phone 10. Although not illustrated in FIGS. 4C and 4D, the battery module 800 may also include magnets on an opposite side of the housing of the battery module 800 from the side shown in FIG. 4C to couple the opposite side to the phone 10. Advantageously, in certain embodiments, the battery module 800 may serve to provide an additional power source for the phone 10 by coupling to the module connector 20 without covering the second cameras 17, so that second cameras 17 remain usable even when the module connector 20 may be in use.

FIG. 4E illustrates a side view of the phone 10 positioned for attachment to an expander module 900, and FIG. 4B illustrates a perspective view of the phone 10 and the expander module 900 when attached. The expander module 900 may include a memory device, a battery, or other component for enhancing the capacity of the phone 10. The expander module 900 may include a housing that supports fastener controls 902A and 902B, fastening elements 935A, 935B, and magnets 904A and 904B, which may be similar to or the same as those provided on the camera module 30 of FIGS. 4A and 4B. For example, the fastening controls may be wheels 902A and 902B configured for rotation by the user, to extend and retract the fastening elements 935A, 935B, which may be threaded screws. In the extended position the fastening elements protrude from the housing for coupling to corresponding holes 937A, 937B in the phone 10. The magnets 904A and 904B may also facilitate coupling of the housing to the phone 10. Although not illustrated in FIGS. 4E and 4F, the expander module 900 may also include fasteners and magnets on an opposite side of the housing of the expander module 900 from the side shown in FIG. 4E to couple the opposite side of the phone 10.

The expander module 900 may also include a module connector 910, similar to or the same as the module connector 20, that may interchangeably couple with a module and receive power and/or data from or transmit power and/or data to the module or one or more other devices coupled to the module. Depending on the embodiment, the couplable module may include a camera, a display, a video game controller, a speaker, a battery, an input/output expander, a light, a lens, a projector, and combinations of the same and the like. For example, the illustrated expander module includes two module connectors including the expander module connector 910 for coupling to a corresponding connector (now shown) on the camera module 30 and another expander module connector (not shown) for coupling to the module connector 20 on the phone 10. Additionally or alternatively, coupling may be achieved at least via a friction fit, interlocking structures, fasteners, mechanical snap surface structures, mechanical latch surface structures, mechanical interference fit surface structures, or the like.

FIG. 4G illustrates a perspective view of the phone 10 positioned for attachment to the expander module 900 and the camera module 30, and FIG. 4H illustrates a perspective view of the phone 10, the expander module 900, and the camera module 30 when attached.

FIG. 5A shows an example module connector 500 positioned on the backside (e.g., non-display side) of a mobile device 502. For example, the connector 500 may an example of the module interface 212 of the mobile device 200, or the connector 20 of the phone 10 shown in FIGS. 1A-1B.

FIG. 5B is a schematic showing an example of a pin assignment for the connector 500. As will be appreciated, the pin assignment for complementary connectors of modules configured to connect to the connector 500 will generally be a mirror image of the pin assignment of the connector 500. As shown, the illustrated connector 500 includes 3 rows 504, 506, 508 of contacts. The top and bottom rows 504, 508 have 13 contacts A1-A13, C1-C13, while the middle row 506 has 12 contacts B1-B12. Here is a mapping of the pins according to one implementation:

| PIN | LABEL | DESCRIPTION |
|---|---|---|
| A1 | MSM_I2C_SCL | Inter-Integrated circuit (I²C) |
| | | bus clock signal. |
| A2 | UART_RX | Universal asynchronous receiver- |
| | | transmitter (UART) bus, receive |
| | | signal. |
| A3 | UART_TX | UART bus transmit signal. |
| A4 | RESET | Reset input. |
| A5 | ATTACH_INT | Module attachment interrupt signal |
| | | indicating that a module has been |
| | | attached, interrupting application |
| | | processor 522 on the phone. |
| A6 | BOOT0 | Boot memory selection control signal. |
| A7 | CAM_MCLK | Camera master clock. E.g., provides |
| | | clock from the application processor |
| | | 522 on the phone 524 to the camera |
| | | module 526. |
| A8 | GROUND | Ground connection. |
| A9 | MIPI_L0_P | Mobile Industry Processor Interface |
| | | (MIPI) bus, differential data lane |
| | | 0, positive signal. |
| A10 | MIPI_L0_M | MIPI bus, differential data lane 0, |
| | | negative signal. |
| A11 | MIPI_L1_P | MIPI bus, differential data lane 1, |
| | | positive signal. |
| A12 | MIPI_L1_M | MIPI bus, differential data lane 1, |
| | | negative signal. |
| A13 | GROUND | Ground connection. |
| B1 | MSM_I2C_SDA | I²C data signal. |
| B2 | PHONE_PWR_OUT | Power signal coming out of the phone |
| | | for powering external devices. |
| B3 | EXT_PWR | Power signal going into phone for |
| | | powering the phone, e.g., from a |
| | | camera module or battery module. |
| B4 | PCIE_RST_N | Peripheral Component Interconnect |
| | | Express bus (PCIe), Reset signal. |
| B5 | ACC_ID | Module identification input. |
| B6 | GROUND | Ground connection. |
| B7 | MIPI_CLK_P | MIPI bus, differential clock lane, |
| | | positive signal. |
| B8 | MIPI_CLK_M | MIPI bus, differential clock lane, |
| | | negative signal. |
| B9 | GROUND | Ground connection. |
| B10 | MIPI_L3_P | MIPI bus, differential data lane 3, |
| | | positive signal. |
| B11 | MIPI_L3_M | MIPI bus, differential data lane 3, |
| | | negative signal. |
| B12 | GROUND | Ground connection. |
| C1 | GROUND | Ground connection. |
| C2 | PCIE_REF_CLK_P | PCIe differential reference clock, |
| | | positive signal. |
| C3 | PCIE_REF_CLK_M | PCIe differential reference clock, |
| | | negative signal. |
| C4 | GROUND | Ground connection. |
| C5 | PCIE_RX_P | PCIe differential data receive lane, |
| | | positive signal. |
| C6 | PCIE_RX_M | PCIe differential data receive lane, |
| | | negative signal. |
| C7 | GROUND | Ground connection. |
| C8 | PCIE_TX_P | PCIe differential data transmit lane, |
| | | positive signal. |
| C9 | PCIE_TX_M | PCIe differential data transmit lane, |
| | | negative signal. |
| C10 | GROUND | Ground connection. |
| C11 | MIPI_L2_P | MIPI bus, differential data lane 2, |
| | | positive signal. |
| C12 | MIPI_L2_M | MIPI bus, differential data lane 2, |
| | | negative signal. |
| C13 | GROUND | Ground. |

FIG. 5C shows a schematic diagram of a camera module 520 (which may be any of the camera modules described herein) connected to an application processor 522 of a mobile device 524 (which may be any of the phones or other mobile devices described herein) over I²C, GPIO, MIPI, and PCIe buses. For example, the camera module 520 and mobile device 524 may be connected using the connector 500 of FIGS. 5A-5B. As shown, the camera module 500 includes a memory card 526 (which may be removable) for storing recorded footage, a processor 528 (which may be an application specific integrated circuit [ASIC], field programmable gate array [FPGA], or the like), operating memory 530 (e.g., SDRAM), a lens controller 532, and one or more image sensors 534.

Referring back to FIGS. 5A and 5B, the connector 500 of the illustrated example implements four different data buses, including I²C (contacts A1, B1), UART (contacts A2, A3), MIPI (A9-A12, B7, B8, B10, B11, C11, C12), and PCIe (B4, C2, C3, C5, C6, C8, C9) buses. A data bus may be used in a manner that exploits the capabilities of the bus. For instance, the MIPI bus may be used to receive and transmit camera data to and from the phone 10 or other mobile device. The MIPI bus may be used to transmit data captured by the cameras provided on the phone 10 to another module or other external device. The MIPI bus may also be used to receive data coming into the phone 10 from external imaging devices such as the camera module 30. The MIPI bus may implement one or both of a MIPI Camera Serial Interface and a MIPI Display Serial Interface, for example. The PCIe bus may be used as a general high speed data transfer bus, such as to transfer large amounts of data (e.g., recorded video or other data files) off of or onto the phone 524.

The I²C and UART bus may be used for control purposes, such as to control operation of the camera module 520 or any other external modules. For instance, one or more of the I²C or UART bus may be used to control the lens, sensors, or other components or operation of the camera module 520. In some embodiments, a general purpose input output bus (GPIO) is implemented, which may be used for control purposes similar to the I²C and UART buses. For instance, the UART contacts may be used to implement a GPIO bus. The UART bus may be used to communicate between the application processor 522 of the phone 500 and the processor 528 of the camera module 520 or other module, such as for updating firmware on the module. The RESET pin may be used to reset one or more processors or other components of the mobile device 524. The ATTACH_INT pin may be used to trigger an interrupt of the application processor 522 of the mobile device 524, indicating that a module has been attached. For instance, the modules may assert the ATTACH_INT pin to a high value when attached.

The Boot0 contact controls boot operation for processors provided in certain modules, such as the processor 528 of the camera module 520. For instance, a low value on the Boot0 pin may indicate that the processor 528 of the camera module 520 should boot from software or firmware local to the processor 528, such as firmware stored in flash memory of the processor 528. Alternatively, a high value on the Boot0 pin may indicate that the processor 528 on the camera module 520 should boot from software or firmware residing on the external memory 530 of the camera module 520. This may allow software or firmware to be loaded onto the memory 530 from the application processor 522 of the mobile device 524, and then loaded into the processor 528 of the module 520, thereby permitting software/firmware updates on the module 520 via the mobile device 524.

The ACC_ID contact may allow the mobile device 524 to identify what type of module is connected. For instance, each module may have a resistor connected to the corresponding ACC_ID contact on the connector of the module, where each type of module has a differently sized resistor. The phone may include circuitry and/or software for determining the size of the resistor and thus the type of the attached, via current measurement or other appropriate means. The physical positioning of the various buses and individual pins may help provide robust operation of the connector 500. For instance, differential signal pairs should generally have the same length and should be positioned next to one another. The illustrated connector 500 follows this design approach, where the positive signal and negative signal for each of the various differential pair are positioned adjacent one another.

Moreover, the ground connections are positioned within the connector 500 in order to help control electrostatic discharge and provide noise isolation. For instance, ground connections are provided between certain bus interfaces to provide robust bus operation. For instance, as shown, each of the following groups of bus pins of the connector 500 are positioned between ground connections: MIPI data pins A9-A12; MIPI clock pins B7, B8; MIPI data pins B10, B11; PCIe clock pins C2, C3; PCIe receive pins C5, C6; PCIe transmit pins C8, C9, and MIPI data pins C11, C12.

### Multi-View Display:

In some embodiments the multi-view display 226 comprises a diffractive lightfield backlighting system incorporating diffractive gratings configured to direct light illuminated thereon into multiple directions each corresponding to a different view of the 3D image. The multi-view display 226 according to some embodiments may produce still or video image data that appears to be in 3D space, such that a user may be able to view the 3D image from multiple directions without moving the display. In some embodiments, the video or still image may appear to be suspended or float above the display, without the need to use special eyewear. Such a display may achieve an effect of allowing the user to “walk around” the displayed footage to observe different views of the video or still images, similar to a holograph.

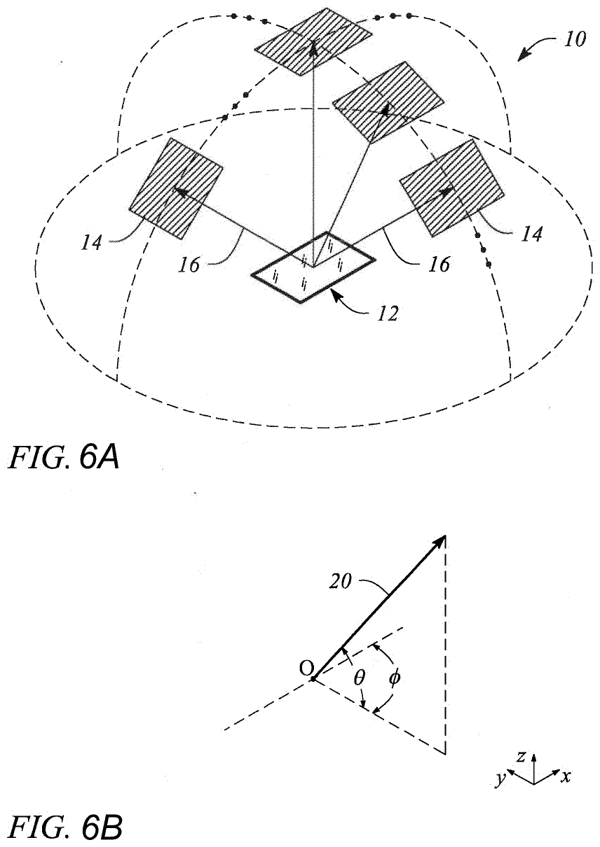

Such content may be referred to as four-dimensional, 4D, 4-view, 3D 4-view, or holographic 4-view because the video or still image content may provide the effect of coming out of the screen, and is enhanced as compared to traditional 3D content. Further examples of multi-view displays including those incorporating diffractive lightfield backlighting are described in further detail herein with respect to FIGS. 6-11.

The multi-view display 226, in some embodiments, may be controlled to selectively display multi-view content or display traditional 2D and/or 3D content. For instance, in one implementation, the video or image file has a flag indicating the type of content, and the video rendering unit 229 or other processor of the mobile device 202 disables the diffractive backlight when displaying 2D or traditional 3D content, and enables the diffractive backlight when displaying multi-view content. In some embodiments, the displays 225 include one or more additional displays 228, which may be 2D or 3D displays, for example.

The displays described herein (such as the display 11 of the device 10 of FIG. 1A and the multi-view display 226 of FIG. 2) can, in some implementations, be or include 3D displays. A 3D display may be configured to produce light so that a 3D image (sometimes referred to as “multi-dimensional content” or “multi-view content”) is observed by the user. Stereoscopic displays may, for instance, be used to form images that appear to a user to be 3D when viewed at the proper angle or using specifically designed eyewear. At least some embodiments are directed to a display that is configured to produce an image that appears to be in 3D space, such that a user may be able to view the 3D image from multiple directions without moving the display. The display may not need to be positioned within the user's field of view. In some embodiments, the 3D image may appear to be suspended or float above the display. Thus, a user may be able to “walk around” the 3D image to observe different views of the image as though the content in the image was a physical object.

Some embodiments of such displays may include a diffractive lightfield backlighting system. The diffractive lightfield backlighting system may include a multi-view or 3D display and a light source configured for rear illumination of the 3D display. The multi-view display may include a plurality of diffractive elements, each including a plurality of diffractive gratings, configured to direct light illuminated thereon into multiple directions. The direction that the light is directed may be based on the diffractive properties of the diffractive elements. In some embodiments, the multiple directions may correspond to a different view of the 3D image. Multiple light rays directed in the same or substantially similar direction may form an image corresponding to a particular view of the 3D content. Accordingly, multiple views of the 3D content may be displayed in multiple directions based on the plurality of diffractive elements.

Some implementations of embodiments herein are described in more detail, for example, in U.S. Pat. No. 9,128,226 entitled “Multibeam Diffraction Grating-Based Backlighting”, U.S. Pat. No. 9,459,461 entitled “Directional Backlighting,” U.S. Pat. No. 10,082,613, U.S. Pat. No. 9,557,466 entitled “Multibeam diffraction grating-based color backlighting”, U.S. Pat. No. 9,785,119 entitled “Multi-view display screen and multi-view mobile device using same”, U.S. Pat. No. 9,389,415 entitled “Directional pixel for use in a display screen”, and International Publication No. WO 2017/204840 entitled “Diffractive Multibeam Element-Based Backlighting”. A 3D display may be separately operable from a 2 Dimensional (2D) display. The 3D display may, for instance, be disposed behind or in front of the 2D display. As such, the 3D display or 2D display may each be turned on and off without affecting the use of the other.

Examples and embodiments in accordance with the principles described herein provide a multi-view or three-dimensional (3D) display and a diffractive multi-view backlight with application to the multi-view display. In particular, embodiments consistent with the principles described herein provide a diffractive multi-view backlight employing an array of diffractive multibeam elements configured to provide light beams having a plurality of different principal angular directions. According to various embodiments, the diffractive multibeam elements each comprise a plurality of diffraction gratings. Further, according to various embodiments, the diffractive multibeam elements are sized relative to sub-pixels of a multi-view pixel in a multi-view display, and may also be spaced apart from one another in a manner corresponding to a spacing of multi-view pixels in the multi-view display. According to various embodiments, the different principal angular directions of the light beams provided by the diffractive multibeam elements of the diffractive multi-view backlight correspond to different directions of various different views of the multi-view display. Herein, a ‘multi-view display’ is defined as an electronic display or display system configured to provide different views of a multi-view image in different view directions.

FIG. 6A illustrates a perspective view of a multi-view display 10 in an example, according to an embodiment consistent with the principles described herein. As illustrated in FIG. 6A, the multi-view display 10 comprises a screen 12 to display a multi-view image to be viewed. The multi-view display 10 provides different views 14 of the multi-view image in different view directions 16 relative to the screen 12. The view directions 16 are illustrated as arrows extending from the screen 12 in various different principal angular directions; the different views 14 are illustrated as shaded polygonal boxes at the termination of the arrows (i.e., depicting the view directions 16); and only four views 14 and four view directions 16 are illustrated, all by way of example and not limitation. Note that while the different views 14 are illustrated in FIG. 6A as being above the screen, the views 14 actually appear on or in a vicinity of the screen 12 when the multi-view image is displayed on the multi-view display 10. Depicting the views 14 above the screen 12 is only for simplicity of illustration and is meant to represent viewing the multi-view display 10 from a respective one of the view directions 16 corresponding to a particular view 14.

A view direction or equivalently a light beam having a direction corresponding to a view direction of a multi-view display generally has a principal angular direction given by angular components {θ, φ}, by definition herein. The angular component 0 is referred to herein as the ‘elevation component’ or ‘elevation angle’ of the light beam. The angular component φ is referred to as the ‘azimuth component’ or ‘azimuth angle’ of the light beam. By definition, the elevation angle θ is an angle in a vertical plane (e.g., perpendicular to a plane of the multi-view display screen while the azimuth angle φ is an angle in a horizontal plane (e.g., parallel to the multi-view display screen plane).

FIG. 6B illustrates a graphical representation of the angular components {θ, φ) of a light beam 20 having a particular principal angular direction corresponding to a view direction (e.g., view direction 16 in FIG. 6A) of a multi-view display in an example, according to an embodiment consistent with the principles described herein. In addition, the light beam 20 is emitted or emanates from a particular point, by definition herein. That is, by definition, the light beam 20 has a central ray associated with a particular point of origin within the multi-view display. FIG. 6B also illustrates the light beam (or view direction) point of origin O.

Further herein, the term ‘multi-view’ as used in the terms ‘multi-view image’ and ‘multi-view display’ is defined as a plurality of views representing different perspectives or including angular disparity between views of the view plurality. In addition, herein the term ‘multi-view’ explicitly includes more than two different views (i.e., a minimum of three views and generally more than three views), by definition herein. As such, ‘multi-view display’ as employed herein is explicitly distinguished from a stereoscopic display that includes only two different views to represent a scene or an image. Note however, while multi-view images and multi-view displays include more than two views, by definition herein, multi-view images may be viewed (e.g., on a multi-view display) as a stereoscopic pair of images by selecting only two of the multi-view views to view at a time (e.g., one view per eye).

A ‘multi-view pixel’ is defined herein as a set of sub-pixels representing ‘view’ pixels in each view of a plurality of different views of a multi-view display. In particular, a multi-view pixel may have an individual sub-pixel corresponding to or representing a view pixel in each of the different views of the multi-view image.

Moreover, the sub-pixels of the multi-view pixel are so-called ‘directional pixels’ in that each of the sub-pixels is associated with a predetermined view direction of a corresponding one of the different views, by definition herein. Further, according to various examples and embodiments, the different view pixels represented by the sub-pixels of a multi-view pixel may have equivalent or at least substantially similar locations or coordinates in each of the different views. For example, a first multi-view pixel may have individual sub-pixels corresponding to view pixels located at {xi, yi} in each of the different views of a multi-view image, while a second multi-view pixel may have individual sub-pixels corresponding to view pixels located at {xi, y2} in each of the different views, and so on.

In some embodiments, a number of sub-pixels in a multi-view pixel may be equal to a number of different views of the multi-view display. For example, the multi-view pixel may provide sixty-four (64) sub-pixels in associated with a multi-view display having 64 different views. In another example, the multi-view display may provide an eight by four array of views (i.e., 32 views) and the multi-view pixel may include thirty-two 32 sub-pixels (i.e., one for each view). Additionally, each different sub-pixel may have an associated direction (e.g., light beam principal angular direction) that corresponds to a different one of the view directions corresponding to the 64 different views, for example.

Further, according to some embodiments, a number of multi-view pixels of the multi-view display may be substantially equal to a number of ‘view’ pixels (i.e., pixels that make up a selected view) in the multi-view display views. For example, if a view includes six hundred forty by four hundred eighty view pixels (i.e., a 640×480 view resolution), the multi-view display may have three hundred seven thousand two hundred (307,200) multi-view pixels. In another example, when the views include one hundred by one hundred pixels, the multi-view display may include a total of ten thousand (i.e., 100×100=10,000) multi-view pixels.

Herein, a ‘light guide’ is defined as a structure that guides light within the structure using total internal reflection. In particular, the light guide may include a core that is substantially transparent at an operational wavelength of the light guide. In various examples, the term ‘light guide’ generally refers to a dielectric optical waveguide that employs total internal reflection to guide light at an interface between a dielectric material of the light guide and a material or medium that surrounds that light guide. By definition, a condition for total internal reflection is that a refractive index of the light guide is greater than a refractive index of a surrounding medium adjacent to a surface of the light guide material. In some embodiments, the light guide may include a coating in addition to or instead of the aforementioned refractive index difference to further facilitate the total internal reflection. The coating may be a reflective coating, for example. The light guide may be any of several light guides including, but not limited to, one or both of a plate or slab guide and a strip guide.

Further herein, the term ‘plate’ when applied to a light guide as in a ‘plate light guide’ is defined as a piece-wise or differentially planar layer or sheet, which is sometimes referred to as a ‘slab’ guide. In particular, a plate light guide is defined as a light guide configured to guide light in two substantially orthogonal directions bounded by a top surface and a bottom surface (i.e., opposite surfaces) of the light guide. Further, by definition herein, the top and bottom surfaces are both separated from one another and may be substantially parallel to one another in at least a differential sense. That is, within any differentially small section of the plate light guide, the top and bottom surfaces are substantially parallel or co-planar.

In some embodiments, the plate light guide may be substantially flat (i.e., confined to a plane) and therefore, the plate light guide is a planar light guide. In other embodiments, the plate light guide may be curved in one or two orthogonal dimensions. For example, the plate light guide may be curved in a single dimension to form a cylindrical shaped plate light guide. However, any curvature has a radius of curvature sufficiently large to insure that total internal reflection is maintained within the plate light guide to guide light.

Herein, a ‘diffraction grating’ is broadly defined as a plurality of features (i.e., diffractive features) arranged to provide diffraction of light incident on the diffraction grating. In some examples, the plurality of features may be arranged in a periodic manner or a quasi-periodic manner. In other examples, the diffraction grating may be a mixed-period diffraction grating that includes a plurality of diffraction gratings, each diffraction grating of the plurality having a different periodic arrangement of features.

Further, the diffraction grating may include a plurality of features (e.g., a plurality of grooves or ridges in a material surface) arranged in a one-dimensional (1D) array. Alternatively, the diffraction grating may comprise a two-dimensional (2D) array of features or an array of features that are defined in two dimensions. The diffraction grating may be a 2D array of bumps on or holes in a material surface, for example. In some examples, the diffraction grating may be substantially periodic in a first direction or dimension and substantially aperiodic (e.g., constant, random, etc.) in another direction across or along the diffraction grating.

As such, and by definition herein, the ‘diffraction grating’ is a structure that provides diffraction of light incident on the diffraction grating. If the light is incident on the diffraction grating from a light guide, the provided diffraction or diffractive scattering may result in, and thus be referred to as, ‘diffractive coupling’ in that the diffraction grating may couple light out of the light guide by diffraction. The diffraction grating also redirects or changes an angle of the light by diffraction (i.e., at a diffractive angle). In particular, as a result of diffraction, light leaving the diffraction grating generally has a different propagation direction than a propagation direction of the light incident on the diffraction grating (i.e., incident light). The change in the propagation direction of the light by diffraction is referred to as ‘diffractive redirection’ herein.

Hence, the diffraction grating may be understood to be a structure including diffractive features that diffractively redirects light incident on the diffraction grating and, if the light is incident from a light guide, the diffraction grating may also diffractively couple out the light from the light guide. Further, by definition herein, the features of a diffraction grating may be referred to as ‘diffractive features’ and may be one or more of at, in and on a material surface (i.e., a boundary between two materials). The surface may be a surface of a light guide, for example. The diffractive features may include any of a variety of structures that diffract light including, but not limited to, one or more of grooves, ridges, holes and bumps at, in or on the surface.

For example, the diffraction grating may include a plurality of substantially parallel grooves in the material surface. In another example, the diffraction grating may include a plurality of parallel ridges rising out of the material surface. The diffractive features (e.g., grooves, ridges, holes, bumps, etc.) may have any of a variety of cross sectional shapes or profiles that provide diffraction including, but not limited to, one or more of a sinusoidal profile, a rectangular profile (e.g., a binary diffraction grating), a triangular profile and a saw tooth profile (e.g., a blazed grating).

According to various examples described herein, a diffraction grating (e.g., a diffraction grating of a diffractive multibeam element, as described below) may be employed to diffractively scatter or couple light out of a light guide (e.g., a plate light guide) as a light beam. In particular, a diffraction angle ΘM of or provided by a locally periodic diffraction grating may be given by equation (1) as:

$${θ}_{m} = {sin}^{- 1} ( n sin {θ}_{i} - \frac{m λ}{d} ) \qquad ( 1 )$$

where λ is a wavelength of the light, m is a diffraction order, n is an index of refraction of a light guide, <i is a distance or spacing between features of the diffraction grating, θt is an angle of incidence of light on the diffraction grating. For simplicity, equation (1) assumes that the diffraction grating is adjacent to a surface of the light guide and a refractive index of a material outside of the light guide is equal to one (i.e., nout=1). In general, the diffraction order m is given by an integer (i.e., m=±1, ±2, . . . ). A diffraction angle ΘM of a light beam produced by the diffraction grating may be given by equation (1). First-order diffraction or more specifically a first-order diffraction angle ΘM is provided when the diffraction order m is equal to one (i.e., m=1).

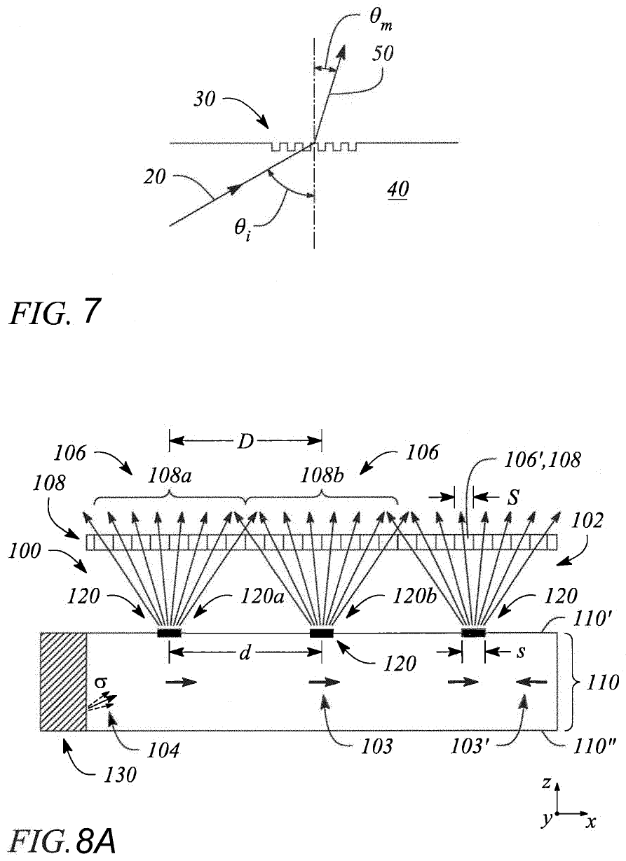

FIG. 7 illustrates a cross sectional view of a diffraction grating 30 in an example, according to an embodiment consistent with the principles described herein. For example, the diffraction grating 30 may be located on a surface of a light guide 40. In addition, FIG. 7 illustrates a light beam 20 incident on the diffraction grating 30 at an incident angle θ1. The light beam 20 is a guided light beam within the light guide 40. Also illustrated in FIG. 7 is a coupled-out light beam 50 diffractively produced and coupled-out by the diffraction grating 30 as a result of diffraction of the incident light beam 20. The coupled-out light beam 50 has a diffraction angle 6 m (or ‘principal angular direction’ herein) as given by equation (1). The coupled-out light beam 50 may correspond to a diffraction order ‘w’ of the diffraction grating 30, for example.

Further, the diffractive features may be curved and may also have a predetermined orientation (e.g., a slant or a rotation) relative to a propagation direction of light, according to some embodiments. One or both of the curve of the diffractive features and the orientation of the diffractive features may be configured to control a direction of light coupled-out by the diffraction grating, for example. For example, a principal angular direction of the coupled-out light may be a function of an angle of the diffractive feature at a point at which the light is incident on the diffraction grating relative to a propagation direction of the incident light.

By definition herein, a ‘multibeam element’ is a structure or element of a backlight or a display that produces light that includes a plurality of light beams. A ‘diffractive’ multibeam element is a multibeam element that produces the plurality of light beams by or using diffractive coupling, by definition. In particular, in some embodiments, the diffractive multibeam element may be optically coupled to a light guide of a backlight to provide the plurality of light beams by diffractively coupling out a portion of light guided in the light guide.

Further, by definition herein, a diffractive multibeam element comprises a plurality of diffraction gratings within a boundary or extent of the multibeam element. The light beams of the plurality of light beams (or ‘light beam plurality’) produced by a multibeam element have different principal angular directions from one another, by definition herein. In particular, by definition, a light beam of the light beam plurality has a predetermined principal angular direction that is different from another light beam of the light beam plurality. According to various embodiments, the spacing or grating pitch of diffractive features in the diffraction gratings of the diffractive multibeam element may be sub-wavelength (i.e., less than a wavelength of the guided light).

According to various embodiments, the light beam plurality may represent a light field. For example, the light beam plurality may be confined to a substantially conical region of space or have a predetermined angular spread that includes the different principal angular directions of the light beams in the light beam plurality. As such, the predetermined angular spread of the light beams in combination (i.e., the light beam plurality) may represent the light field. According to various embodiments, the different principal angular directions of the various light beams in the light beam plurality are determined by a characteristic including, but not limited to, a size (e.g., one or more of length, width, area, and etc.) of the diffractive multibeam element along with a ‘grating pitch’ or a diffractive feature spacing and an orientation of a diffraction grating within diffractive multibeam element. In some embodiments, the diffractive multibeam element may be considered an ‘extended point light source’, i.e., a plurality of point light sources distributed across an extent of the diffractive multibeam element, by definition herein. Further, a light beam produced by the diffractive multibeam element has a principal angular direction given by angular components {θ, φ}, by definition herein, and as described above with respect to FIG. 6B.

Herein a ‘collimator’ is defined as substantially any optical device or apparatus that is configured to collimate light. For example, a collimator may include, but is not limited to, a collimating mirror or reflector, a collimating lens, or various combinations thereof. In some embodiments, the collimator comprising a collimating reflector may have a reflecting surface characterized by a parabolic curve or shape. In another example, the collimating reflector may comprise a shaped parabolic reflector. By ‘shaped parabolic’ it is meant that a curved reflecting surface of the shaped parabolic reflector deviates from a ‘true’ parabolic curve in a manner determined to achieve a predetermined reflection characteristic (e.g., a degree of collimation). Similarly, a collimating lens may comprise a spherically shaped surface (e.g., a biconvex spherical lens).

In some embodiments, the collimator may be a continuous reflector or a continuous lens (i.e., a reflector or lens having a substantially smooth, continuous surface). In other embodiments, the collimating reflector or the collimating lens may comprise a substantially discontinuous surface such as, but not limited to, a Fresnel reflector or a Fresnel lens that provides light collimation. According to various embodiments, an amount of collimation provided by the collimator may vary in a predetermined degree or amount from one embodiment to another. Further, the collimator may be configured to provide collimation in one or both of two orthogonal directions (e.g., a vertical direction and a horizontal direction). That is, the collimator may include a shape in one or both of two orthogonal directions that provides light collimation, according to some embodiments.

Herein, a ‘collimation factor,’ denoted σ, is defined as a degree to which light is collimated. In particular, a collimation factor defines an angular spread of light rays within a collimated beam of light, by definition herein. For example, a collimation factor σ may specify that a majority of light rays in a beam of collimated light is within a particular angular spread (e.g., +/−σ degrees about a central or principal angular direction of the collimated light beam). The light rays of the collimated light beam may have a Gaussian distribution in terms of angle and the angular spread may be an angle determined at one-half of a peak intensity of the collimated light beam, according to some examples.

Herein, a ‘light source’ is defined as a source of light (e.g., an optical emitter configured to produce and emit light). For example, the light source may comprise an optical emitter such as a light emitting diode (LED) that emits light when activated or turned on. In particular, herein, the light source may be substantially any source of light or comprise substantially any optical emitter including, but not limited to, one or more of a light emitting diode (LED), a laser, an organic light emitting diode (OLED), a polymer light emitting diode, a plasma-based optical emitter, a fluorescent lamp, an incandescent lamp, and virtually any other source of light.

The light produced by the light source may have a color (i.e., may include a particular wavelength of light), or may be a range of wavelengths (e.g., white light). In some embodiments, the light source may comprise a plurality of optical emitters. For example, the light source may include a set or group of optical emitters in which at least one of the optical emitters produces light having a color, or equivalently a wavelength, that differs from a color or wavelength of light produced by at least one other optical emitter of the set or group. The different colors may include primary colors (e.g., red, green, blue) for example.

Further, as used herein, the article ‘a’ is intended to have its ordinary meaning in the patent arts, namely ‘one or more’. For example, ‘an element’ means one or more elements and as such, ‘the element’ means ‘the element(s)’ herein. Also, any reference herein to ‘top’, ‘bottom’, ‘upper’, ‘lower’, ‘up’, ‘down’, ‘front’, back’, ‘first’, ‘second’, ‘left’ or ‘right’ is not intended to be a limitation herein. Herein, the term ‘about’ when applied to a value generally means within the tolerance range of the equipment used to produce the value, or may mean plus or minus 10%, or plus or minus 5%, or plus or minus 1%, unless otherwise expressly specified. Further, the term ‘substantially’ as used herein means a majority, or almost all, or all, or an amount within a range of about 51% to about 100%. Moreover, examples herein are intended to be illustrative only and are presented for discussion purposes and not by way of limitation.

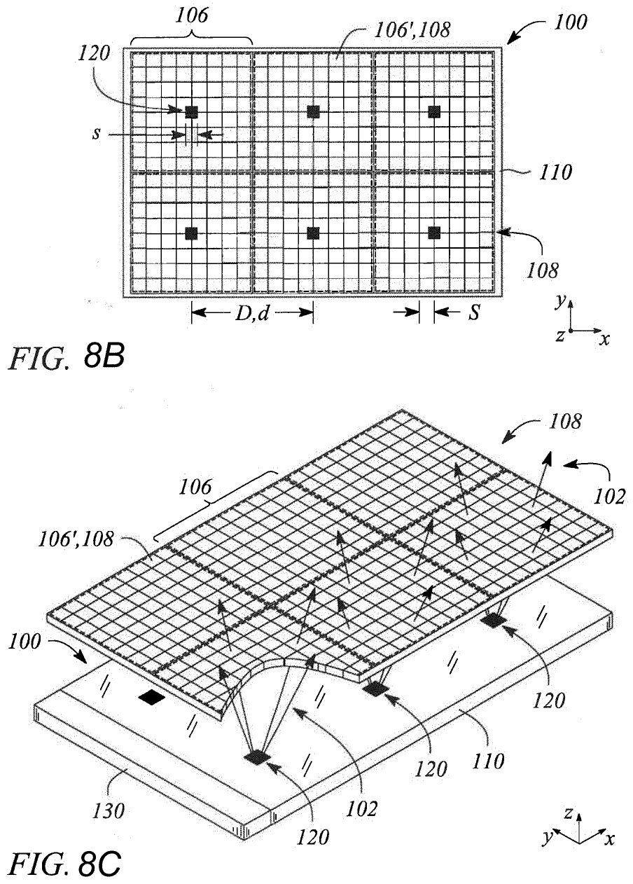

According to some embodiments of the principles described herein, a diffractive multi-view backlight is provided. FIG. 8A illustrates a cross sectional view of a diffractive multi-view backlight 100 in an example, according to an embodiment consistent with the principles described herein. FIG. 8B illustrates a plan view of a diffractive multi-view backlight 100 in an example, according to an embodiment consistent with the principles described herein. FIG. 8C illustrates a perspective view of a diffractive multi-view backlight 100 in an example, according to an embodiment consistent with the principles described herein. The perspective view in FIG. 8C is illustrated with a partial cut-away to facilitate discussion herein only.

The diffractive multi-view backlight 100 illustrated in FIGS. 8A-8C is configured to provide a plurality of coupled-out light beams 102 having different principal angular directions from one another (e.g., as a light field). In particular, the provided plurality of coupled-out light beams 102 are diffractively coupled out and directed away from the diffractive multi-view backlight 100 in different principal angular directions corresponding to respective view directions of a multi-view display, according to various embodiments. In some embodiments, the coupled-out light beams 102 may be modulated (e.g., using light valves, as described below) to facilitate the display of information having three-dimensional (3D) content. FIGS. 8A-8C also illustrate a multi-view pixel 106 comprising sub-pixels 106′ and an array of light valves 108, which are described in further detail below.

As illustrated in FIGS. 8A-8C, the diffractive multi-view backlight 100 comprises a light guide 110. The light guide 110 is configured to guide light along a length of the light guide 110 as guided light 104 (i.e., a guided light beam 104). For example, the light guide 110 may include a dielectric material configured as an optical waveguide. The dielectric material may have a first refractive index that is greater than a second refractive index of a medium surrounding the dielectric optical waveguide. The difference in refractive indices is configured to facilitate total internal reflection of the guided light 104 according to one or more guided modes of the light guide 110, for example.

In some embodiments, the light guide 110 may be a slab or plate optical waveguide (i.e., a plate light guide) comprising an extended, substantially planar sheet of optically transparent, dielectric material. The substantially planar sheet of dielectric material is configured to guide the guided light beam 104 using total internal reflection. According to various examples, the optically transparent material of the light guide 110 may include or be made up of any of a variety of dielectric materials including, but not limited to, one or more of various types of glass (e.g., silica glass, alkali-aluminosilicate glass, borosilicate glass, etc.) and substantially optically transparent plastics or polymers (e.g., poly(methyl methacrylate) or ‘acrylic glass’, polycarbonate, etc.). In some examples, the light guide 110 may further include a cladding layer (not illustrated) on at least a portion of a surface (e.g., one or both of the top surface and the bottom surface) of the light guide 110. The cladding layer may be used to further facilitate total internal reflection, according to some examples.

Further, according to some embodiments, the light guide 110 is configured to guide the guided light beam 104 according to total internal reflection at a non-zero propagation angle between a first surface 110′ (e.g., ‘front’ surface or side) and a second surface 110″ (e.g., ‘back’ surface or side) of the light guide 110. In particular, the guided light beam 104 propagates by reflecting or ‘bouncing’ between the first surface 110′ and the second surface 110″ of the light guide 110 at the non-zero propagation angle. In some embodiments, a plurality of guided light beams 104 comprising different colors of light may be guided by the light guide 110 at respective ones of different color-specific, nonzero propagation angles. Note, the non-zero propagation angle is not illustrated in FIGS. 8A-8C for simplicity of illustration. However, a bold arrow depicting a propagation direction 103 illustrates a general propagation direction of the guided light 104 along the light guide length in FIG. 8A.

As defined herein, a ‘non-zero propagation angle’ is an angle relative to a surface (e.g., the first surface 110′ or the second surface 110″) of the light guide 110. Further, the non-zero propagation angle is both greater than zero and less than a critical angle of total internal reflection within the light guide 110, according to various embodiments. For example, the non-zero propagation angle of the guided light beam 104 may be between about ten (10) degrees and about fifty (50) degrees or, in some examples, between about twenty (20) degrees and about forty (40) degrees, or between about twenty-five (25) degrees and about thirty -five (35) degrees. For example, the non-zero propagation angle may be about thirty (30) degrees. In other examples, the non-zero propagation angle may be about 20 degrees, or about 25 degrees, or about 35 degrees. Moreover, a specific non-zero propagation angle may be chosen (e.g., arbitrarily) for a particular implementation as long as the specific non-zero propagation angle is chosen to be less than the critical angle of total internal reflection within the light guide 110.

The guided light beam 104 in the light guide 110 may be introduced or coupled into the light guide 110 at the non-zero propagation angle (e.g., about 30-35 degrees). In some examples, a coupling structure such as, but not limited to, a lens, a mirror or similar reflector (e.g., a tilted collimating reflector), a diffraction grating and a prism (not illustrated) as well as various combinations thereof may facilitate coupling light into an input end of the light guide 110 as the guided light beam 104 at the non-zero propagation angle. In other examples, light may be introduced directly into the input end of the light guide 110 either without or substantially without the use of a coupling structure (i.e., direct or ‘butt’ coupling may be employed). Once coupled into the light guide 110, the guided light beam 104 is configured to propagate along the light guide 110 in a direction 103 that may be generally away from the input end (e.g., illustrated by bold arrows pointing along an x-axis in FIG. 8A).

Further, the guided light 104, or equivalently the guided light beam 104, produced by coupling light into the light guide 110 may be a collimated light beam, according to various embodiments. Herein, a ‘collimated light’ or a ‘collimated light beam’ is generally defined as a beam of light in which rays of the light beam are substantially parallel to one another within the light beam (e.g., the guided light beam 104). Further, rays of light that diverge or are scattered from the collimated light beam are not considered to be part of the collimated light beam, by definition herein. In some embodiments, the diffractive multi-view backlight 100 may include a collimator, such as a lens, reflector or mirror, as described above, (e.g., tilted collimating reflector) to collimate the light, e.g., from a light source. In some embodiments, the light source comprises a collimator. The collimated light provided to the light guide 110 is a collimated guided light beam 104. The guided light beam 104 may be collimated according to or having a collimation factor σ, in various embodiments.

In some embodiments, the light guide 110 may be configured to ‘recycle’ the guided light 104. In particular, the guided light 104 that has been guided along the light guide length may be redirected back along that length in another propagation direction 103′ that differs from the propagation direction 103. For example, the light guide 110 may include a reflector (not illustrated) at an end of the light guide 110 opposite to an input end adjacent to the light source. The reflector may be configured to reflect the guided light 104 back toward the input end as recycled guided light.

In some embodiments, another light source may provide guided light 104 in the other propagation direction 103′ instead of or in addition to light recycling (e.g., using a reflector). One or both of recycling the guided light 104 and using another light source to provide guided light 104 having the other propagation direction 103′ may increase a brightness of the diffractive multi-view backlight 100 (e.g., increase an intensity of the coupled-out light beams 102) by making guided light available more than once, for example, to diffractive multibeam elements, described below.

In FIG. 8A, a bold arrow indicating a propagation direction 103′ of recycled guided light (e.g., directed in a negative x-direction) illustrates a general propagation direction of the recycled guided light within the light guide 110. Alternatively (e.g., as opposed to recycling guided light), guided light 104 propagating in the other propagation direction 103′ may be provided by introducing light into the light guide 110 with the other propagation direction 103′ (e.g., in addition to guided light 104 having the propagation direction 103). As illustrated in FIGS. 8A-8C, the diffractive multi-view backlight 100 further comprises a plurality of diffractive multibeam elements 120 spaced apart from one another along the light guide length.

In particular, the diffractive multibeam elements 120 of the plurality are separated from one another by a finite space and represent individual, distinct elements along the light guide length. That is, by definition herein, the diffractive multibeam elements 120 of the plurality are spaced apart from one another according to a finite (i.e., non-zero) inter-element distance (e.g., a finite center-to-center distance). Further, the diffractive multibeam elements 120 of the plurality generally do not intersect, overlap or otherwise touch one another, according to some embodiments. That is, each diffractive multibeam element 120 of the plurality is generally distinct and separated from other ones of the diffractive multibeam elements 120.

According to some embodiments, the diffractive multibeam elements 120 of the plurality may be arranged in either a one-dimensional (1D) array or a two-dimensional (2D) array. For example, the diffractive multibeam elements 120 may be arranged as a linear ID array. In another example, the diffractive multibeam elements 120 may be arranged as a rectangular 2D array or as a circular 2D array. Further, the array (i.e., ID or 2D array) may be a regular or uniform array, in some examples. In particular, an inter-element distance (e.g., center-to-center distance or spacing) between the diffractive multibeam elements 120 may be substantially uniform or constant across the array. In other examples, the inter-element distance between the diffractive multibeam elements 120 may be varied one or both of across the array and along the length of the light guide 110.

According to various embodiments, a diffractive multibeam element 120 of the plurality comprises a plurality of diffraction gratings configured to couple out a portion of the guided light 104 as the plurality of coupled-out light beams 102. In particular, the guided light portion is coupled out by the plurality of diffraction gratings using diffractive coupling, according to various embodiments. FIGS. 8A and 8C illustrate the coupled-out light beams 102 as a plurality of diverging arrows depicted as being directed way from the first (or front) surface 110′ of the light guide 110. Further, according to various embodiments, a size of the diffractive multibeam element 120 is comparable to a size of a sub-pixel 106′ in a multi-view pixel 106 of a multi-view display, as defined above and further described below.

The multi-view pixels 106 are illustrated in FIGS. 8A-8C with the diffractive multi-view backlight 100 for the purpose of facilitating discussion. Herein, the ‘size’ may be defined in any of a variety of manners to include, but not be limited to, a length, a width or an area. For example, the size of a sub-pixel 106′ may be a length thereof and the comparable size of the diffractive multibeam element 120 may also be a length of the diffractive multibeam element 120. In another example, the size may refer to an area such that an area of the diffractive multibeam element 120 may be comparable to an area of the sub-pixel 106′.

In some embodiments, the size of the diffractive multibeam element 120 is comparable to the sub-pixel size such that the diffractive multibeam element size is between about fifty percent (50%) and about two hundred percent (200%>) of the sub-pixel size. For example, if the diffractive multibeam element size is denoted and the sub-pixel size is denoted ‘S’ (e.g., as illustrated in FIG. 8A), then the diffractive multibeam element size s may be given by:

1/2S≤s≤2S

In other examples, the diffractive multibeam element size is in a range that is greater than about sixty percent (60%) of the sub-pixel size, or greater than about seventy percent (70%)) of the sub-pixel size, or greater than about eighty percent (80%) of the sub-pixel size, or greater than about ninety percent (90%) of the sub-pixel size, and that is less than about one hundred eighty percent (180%) of the sub-pixel size, or less than about one hundred sixty percent (160%) of the sub-pixel size, or less than about one hundred forty (140%)) of the sub-pixel size, or less than about one hundred twenty percent (120%) of the sub-pixel size. For example, by ‘comparable size’, the diffractive multibeam element size may be between about seventy -five percent (75%) and about one hundred fifty (150%) of the sub-pixel size. In another example, the diffractive multibeam element 120 may be comparable in size to the sub-pixel 106′ where the diffractive multibeam element size is between about one hundred twenty -five percent (125%) and about eighty-five percent (85%>) of the sub-pixel size.

According to some embodiments, the comparable sizes of the diffractive multibeam element 120 and the sub-pixel 106′ may be chosen to reduce, or in some examples to minimize, dark zones between views of the multi-view display. Moreover, the comparable sizes of the diffractive multibeam element 120 and the sub-pixel 106′ may be chosen to reduce, and in some examples to minimize, an overlap between views (or view pixels) of the multi-view display.

FIGS. 8A-8C further illustrate an array of light valves 108 configured to modulate the coupled-out light beams 102 of the coupled-out light beam plurality. The light valve array may be part of a multi-view display that employs the diffractive multi-view backlight 100, for example, and is illustrated in FIGS. 8A-8C along with the diffractive multi-view backlight 100 for the purpose of facilitating discussion herein. In FIG. 8C, the array of light valves 108 is partially cut-away to allow visualization of the light guide 110 and the diffractive multibeam element 120 underlying the light valve array, for discussion purposes only.

As illustrated in FIGS. 8A-8C, different ones of the coupled-out light beams 102 having different principal angular directions pass through and may be modulated by different ones of the light valves 108 in the light valve array. Further, as illustrated, a light valve 108 of the array corresponds to a sub-pixel 106′ of the multi-view pixel 106, and a set of the light valves 108 corresponds to a multi-view pixel 106 of the multi-view display. In particular, a different set of light valves 108 of the light valve array is configured to receive and modulate the coupled-out light beams 102 from a corresponding one of the diffractive multibeam elements 120, i.e., there is one unique set of light valves 108 for each diffractive multibeam element 120, as illustrated. In various embodiments, different types of light valves may be employed as the light valves 108 of the light valve array including, but not limited to, one or more of liquid crystal light valves, electrophoretic light valves, and light valves based on electrowetting.

As illustrated in FIG. 8A, a first light valve set 108a is configured to receive and modulate the coupled-out light beams 102 from a first diffractive multibeam element 120a. Further, a second light valve set 108b is configured to receive and modulate the coupled-out light beams 102 from a second diffractive multibeam element 120b. Thus, each of the light valve sets (e.g., the first and second light valve sets 108a, 108b) in the light valve array corresponds, respectively, both to a different diffractive multibeam element 120 (e.g., elements 120a, 120b) and to a different multi-view pixel 106, with individual light valves 108 of the light valve sets corresponding to the sub-pixels 106′ of the respective multi-view pixels 106, as illustrated in FIG. 8A.

Note that, as illustrated in FIG. 8A, the size of a sub-pixel 106′ of a multi-view pixel 106 may correspond to a size of a light valve 108 in the light valve array. In other examples, the sub-pixel size may be defined as a distance (e.g., a center-to-center distance) between adjacent light valves 108 of the light valve array. For example, the light valves 108 may be smaller than the center-to-center distance between the light valves 108 in the light valve array. The sub-pixel size may be defined as either the size of the light valve 108 or a size corresponding to the center-to-center distance between the light valves 108, for example.

In some embodiments, a relationship between the diffractive multibeam elements 120 and corresponding multi-view pixels 106 (i.e., sets of sub-pixels 106′ and corresponding sets of light valves 108) may be a one-to-one relationship. That is, there may be an equal number of multi-view pixels 106 and diffractive multibeam elements 120. FIG. 8B explicitly illustrates by way of example the one-to-one relationship where each multi-view pixel 106 comprising a different set of light valves 108 (and corresponding sub-pixels 106′) is illustrated as surrounded by a dashed line. In other embodiments (not illustrated), the number of multi-view pixels 106 and the number diffractive multibeam elements 120 may differ from one another.

In some embodiments, an inter-element distance (e.g., center-to-center distance) between a pair of diffractive multibeam elements 120 of the plurality may be equal to an inter-pixel distance (e.g., a center-to-center distance) between a corresponding pair of multi-view pixels 106, e.g., represented by light valve sets. For example, as illustrated in FIG. 8A, a center-to-center distance d between the first diffractive multibeam element 120a and the second diffractive multibeam element 120b is substantially equal to a center-to-center distance D between the first light valve set 108a and the second light valve set 108b. In other embodiments (not illustrated), the relative center-to-center distances of pairs of diffractive multibeam elements 120 and corresponding light valve sets may differ, e.g., the diffractive multibeam elements 120 may have an inter-element spacing (i.e., center-to-center distance d) that is one of greater than or less than a spacing (i.e., center-to-center distance D) between light valve sets representing multi-view pixels 106.

In some embodiments, a shape of the diffractive multibeam element 120 is analogous to a shape of the multi-view pixel 106 or equivalently, to a shape of a set (or ‘sub-array’) of the light valves 108 corresponding to the multi-view pixel 106. For example, the diffractive multibeam element 120 may have a square shape and the multi-view pixel 106 (or an arrangement of a corresponding set of light valves 108) may be substantially square. In another example, the diffractive multibeam element 120 may have a rectangular shape, i.e., may have a length or longitudinal dimension that is greater than a width or transverse dimension.

In this example, the multi-view pixel 106 (or equivalently the arrangement of the set of light valves 108) corresponding to the diffractive multibeam element 120 may have an analogous rectangular shape. FIG. 8B illustrates a top or plan view of square-shaped diffractive multibeam elements 120 and corresponding square-shaped multi-view pixels 106 comprising square sets of light valves 108. In yet other examples (not illustrated), the diffractive multibeam elements 120 and the corresponding multi-view pixels 106 have various shapes including or at least approximated by, but not limited to, a triangular shape, a hexagonal shape, and a circular shape.

Further (e.g., as illustrated in FIG. 8A), each diffractive multibeam element 120 is configured to provide coupled-out light beams 102 to one and only one multi-view pixel 106, according to some embodiments. In particular, for a given one of the diffractive multibeam elements 120, the coupled-out light beams 102 having different principal angular directions corresponding to the different views of the multi-view display are substantially confined to a single corresponding multi-view pixel 106 and the sub-pixels 106′ thereof, i.e., a single set of light valves 108 corresponding to the diffractive multibeam element 120, as illustrated in FIG. 8A. As such, each diffractive multibeam element 120 of the diffractive multi-view backlight 100 provides a corresponding set of coupled-out light beams 102 that has a set of the different principal angular directions corresponding to the different views of the multi-view display (i.e., the set of coupled-out light beams 102 contains a light beam having a direction corresponding to each of the different view directions).

According to various embodiments, each diffractive multibeam element 120 comprises a plurality of diffraction gratings 122. The diffractive multibeam element 120, or more particularly the plurality of diffraction gratings of the diffractive multibeam element 120, may be located either on, at or adjacent to a surface of the light guide 110 or between the light guide surfaces.

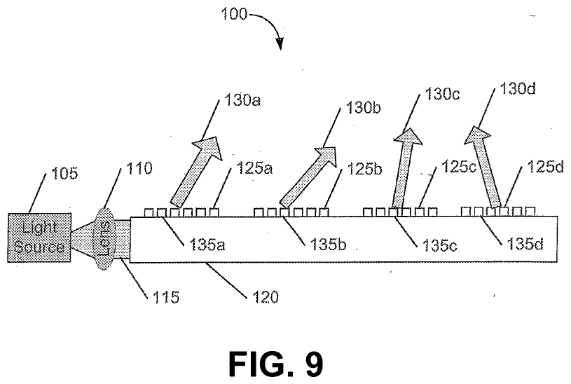

FIGS. 9-11 describe additional examples of directional backlights. The directional backlight uses a plurality of light sources to generate a plurality of input planar lightbeams for a directional backplane. The directional backplane is composed of a plurality of directional pixels that guide the input planar lightbeams and scatter a fraction of them into output directional lightbeams. The input planar lightbeams propagate in substantially the same plane as the directional backplane, which is designed to be substantially planar.

Referring back to FIG. 9, a schematic diagram of a directional backlight in accordance with various embodiments is described. Directional backlight 100 includes a single-color light source 105 disposed behind a lens component 110 to generate a collimated input planar lightbeam 115 for the directional backplane 120. The lens component 110 may include a cylindrical lens, an aspheric condenser lens combined with a cylindrical lens, a microlens, or any other optical combination for collimating and focusing the input planar lightbeam 115 into the directional backplane 120. The directional backplane 120 may be comprised of a slab of a transparent material (e.g., SiN, glass or quartz, plastic, ITO, etc.) having a plurality of directional pixels 125a-d arranged in or on top of the directional backplane 120. The directional pixels 125a-d scatter a fraction of the input planar lightbeam 115 into output directional lightbeams 130a-d.

In various embodiments, each directional pixel 125a-125d has patterned gratings of substantially parallel and slanted grooves, e.g., grooves 135a for directional pixel 125a. The thickness of the grating grooves may be substantially the same for all grooves resulting in a substantially planar design. The grooves may be etched in the directional backplane or be made of material deposited on top of the directional backplane 120 (e.g., any material that may be deposited and etched or lift-off, including any dielectrics or metal).

Each directional lightbeam 130a-d has a given direction and an angular spread that is determined by the patterned gratings in its corresponding directional pixel 125a-d. In particular, the direction of each directional lightbeam 130a-d is determined by the orientation and the grating pitch of the patterned gratings. The angular spread of each directional lightbeam is in turn determined by the grating length and width of the patterned gratings. For example, the direction of directional lightbeam 130a is determined by the orientation and the grating pitch of patterned gratings 135a.

It is appreciated that this substantially planar design and the formation of directional lightbeams 130a-d upon an input planar lightbeam 115 requires a grating with a substantially smaller pitch than traditional diffraction gratings. For example, traditional diffraction gratings scatter light upon illumination with lightbeams that are propagating substantially across the plane of the grating. Here, the gratings in each directional pixel 125a-d are substantially on the same plane as the input planar lightbeam 115 when generating the directional lightbeams 130a-d. This planar design enables illumination with the light source 105.

The directional lightbeams 130a-d are precisely controlled by characteristics of the gratings in directional pixels 125a-d including a grating length L, a grating width W, a groove orientation angle θ, and a grating pitch L. In particular, the grating length L of grating 135 a controls the angular spread ΔΘ of the directional lightbeam 130a along the input light propagation axis and the grating width W controls the angular spread ΔΘ of the directional lightbeam 130 a across the input light propagation axis, as follows:

ΔΘ≈4λπL(4λπW) (Eq. 1)

where λ is the wavelength of the directional lightbeam 130a. The groove orientation, specified by the grating orientation angle θ, and the grating pitch or period, specified by A, control the direction of the directional lightbeam 130a.

The grating length L and the grating width W may vary in size in the range of 0.1 to 200 μm. The groove orientation angle θ and the grating pitch A may be set to satisfy a desired direction of the directional lightbeam 130a, with, for example, the groove orientation angle θ on the order of −40 to +40 degrees and the grating pitch A on the order of 200-700 nm.

It is appreciated that directional backplane 120 is shown with four directional pixels 125a-d for illustration purposes only. A directional backplane in accordance with various embodiments may be designed with many directional pixels (e.g., higher than 100), depending on how the directional backplane 120 is used (e.g., in a 3D display screen, in a 3D watch, in a mobile device, etc.). It is also appreciated that the directional pixels may have any shape, including for example, a circle, an ellipse, a polygon, or other geometrical shape. Further, it is appreciated that any narrow-bandwidth light source may be used to generate the input planar lightbeam 115 (e.g., a laser or LED).

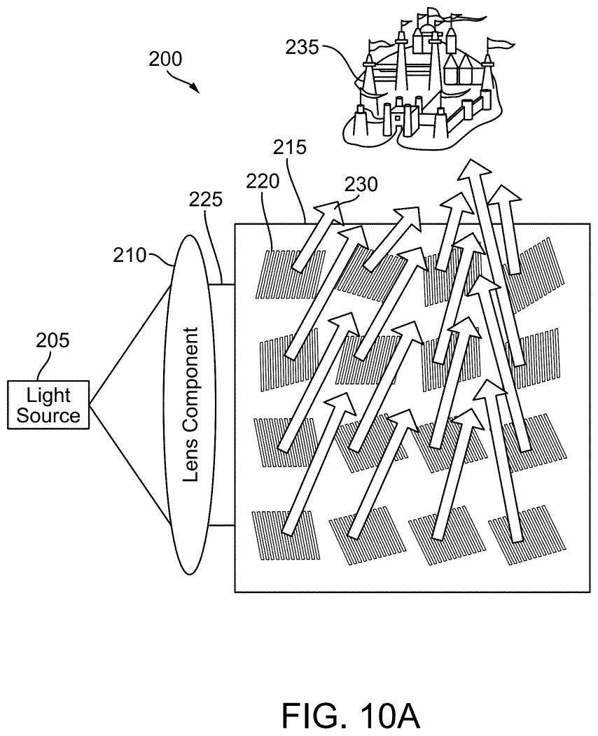

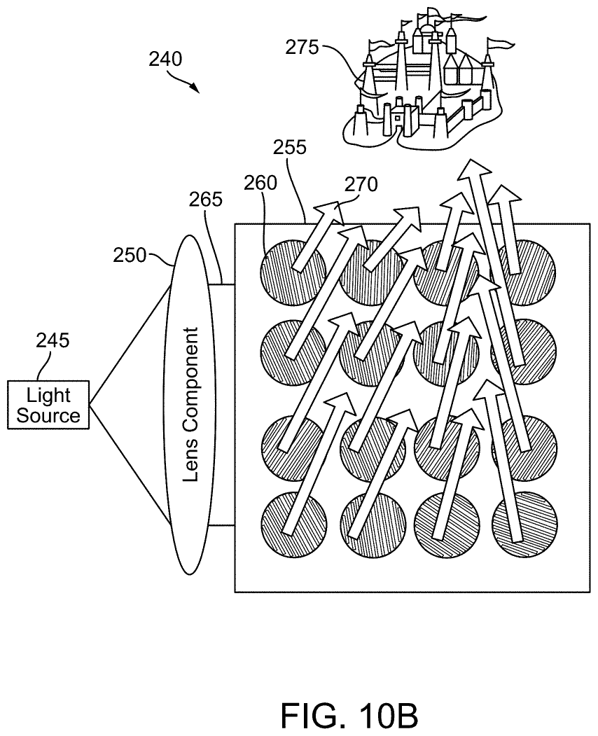

Attention is now directed to FIGS. 10A-10B, which illustrate top views of a directional backlight according to FIG. 9. In FIG. 10A, directional backlight 200 is show with a single-color light source 205 (e.g., an LED), a lens component 210 and a directional backplane 215 comprising of a plurality of polygonal directional pixels (e.g., directional pixel 220) arranged in a transparent slab. Each directional pixel is able to scatter a portion of the input planar lightbeam 225 from the light source 205 into an output directional lightbeam (e.g., directional lightbeam 230). The directional lightbeams scattered by all the directional pixels in the directional backplane 215 may represent multiple image views that when combined form a 3D image, such as, for example, 3D image 235.

Similarly, in FIG. 10B, directional backlight 240 is shown with a single-color light source 245 (e.g., an LED), a lens component 250 and a directional backplane 255 comprising of a plurality of circular directional pixels (e.g., directional pixel 260) arranged in a transparent slab. Each directional pixel is able to scatter a portion of the input planar lightbeam 265 from the light source 245 into an output directional lightbeam (e.g., directional lightbeam 270). The directional lightbeams scattered by all the directional pixels in the directional backplane 255 may represent multiple image views that when combined form a 3D image, such as, for example, 3D image 275.

In various embodiments, the input planar lightbeam 225 (265) from the light source 205 (245) may be further collimated into the directional backplane 215 (255) by using a baffle or absorber that regulates the angular divergence of light from the light source 205 (245).

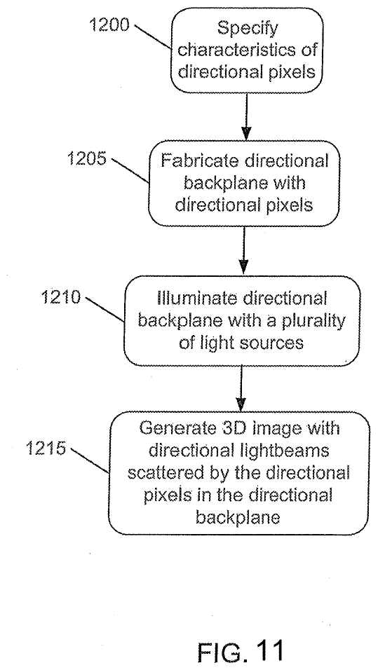

A flowchart for generating a 3D image with a directional backlight in accordance with various embodiments is illustrated in FIG. 11. First, the characteristics of the directional pixels of the directional backlight are specified (1200). The characteristics may include characteristics of the patterned gratings in the directional pixels, such as, for example, a grating length, a grating width, an orientation, a pitch, and a duty cycle. As described above, each directional pixel in the directional backlight may be specified with a given set of characteristics to generate a directional lightbeam having a direction and an angular spread that is precisely controlled according to the characteristics.

A directional backplane with directional pixels may be fabricated (1205). The directional backplane is made of a transparent material and may be fabricated with any suitable fabrication technique, such as, for example, optical lithography, nano-imprint lithography, roll-to-roll imprint lithography, direct embossing with an imprint mold, among others. The directional pixels may be etched in the directional backplane or be made of patterned gratings with material deposited on top of the directional backplane (e.g., any material that may be deposited and etched or lift-off, including any dielectrics or metal).

Light from a plurality of light sources is input into the directional backplane in the form of input planar lightbeams (1210). Lastly, a 3D image is generated from the directional lightbeams that are scattered by the directional pixels in the directional backplane (1215). Other embodiments of the 3D display are possible for generating a 3D or multi-view image. For example, the 3D display may be configured to display a 3D image based on a reconstruction of a holographic interference pattern associated with a hologram. The interference pattern may be reconstructed based on features stored in the fringe pattern, and the display may include pixels driven to duplicate the interference fringe pattern on a screen.

The pixels may be illuminated by a light source, which may be transformed (e.g., varied in phase or transmittance) by the interference pattern of the pixels to generate a 3D holographic image. Some implementations may be found in, for example, U.S. Pat. No. 9,304,491, entitled “Transparent Holographic Display with Dynamic Image Control”; U.S. Pat. No. 6,760,135, entitled “Holographic Display”. In another embodiment, the display may include a plurality of holographic pixels that are illuminated modulated using a spatial light modulator, for example, as described in U.S. Pat. No. 7,190,496, entitled “Enhanced Environment Visualization Using Holographic Sterograms.”

Advantageously, the 3D display may, in certain embodiments, not need to utilize lenticular lenses or eye tracking technology. Without subscribing to a particular scientific theory, embodiments herein may provide for higher resolution as compared to displays using lenticular lenses, the 3D display may be separately operable from a standard 2D display, and the 3D display provides for multi-directional content having multiple views.

Moreover, the image capture devices described herein can, in some implementations, capture 3D images for reproduction by a 3D display. For instance, the first cameras 12, the second cameras 17, images sensors of the camera module 30, or image sensors of the video camera may be used to capture 3D images. In one example, the first cameras 12, the second cameras 17, or the images sensors of the camera module 30 may be used to capture 3D images, and the phone 10 may in turn store the 3D images and playback the 3D images using the display 11. Such a design may facilitate live or simultaneous capture and display of 3D images.

The 3D content, holographic content, or other content displayed on the 3D display may be compressed according to any of the techniques described herein, such as for example according to the techniques for compressing raw image data described with respect to FIGS. 3A-6. For instance, the phone 10 may capture compressed raw image data using two or more of the first cameras 12, using the second cameras 17, or one or more of the image sensors of the camera module 30 (or using a different camera module attached to the phone 10). The phone 10 may then record the compressed image data in one or more files on a memory device of the phone 10, or in a memory device in a module attached to the phone 10. The phone 10 may then access the image data, decompress it, and prepare it for playback on the display 11 as 3D, holographic content, or the like, as appropriate. The phone 10 may additionally according to some embodiments play the 3D, holographic, or other content back in real-time without first compressing and storing the content, while the phone 10 is recording.

### Multi-Dimensional Audio:

The mobile device 202 may additionally include one or more microphone(s) 230 configured to detect sounds, convert the detected sound to electrical signals, and output the signals to the audio processing unit 232. The audio processing unit 232 may generate an audio file for storage in the memory 227, such as when the user is recording parallel video and audio using the cameras 222 and the microphones 230. The audio processing unit 232 may alternatively stream audio to phone electronics 236 for transmission via the antenna 238, such as during a phone call. In some embodiments, the mobile device 202 includes two microphones 230 that provide left and right channel sound, which the audio processing unit 232 uses to create a stereo audio file that is stored in the memory 227.

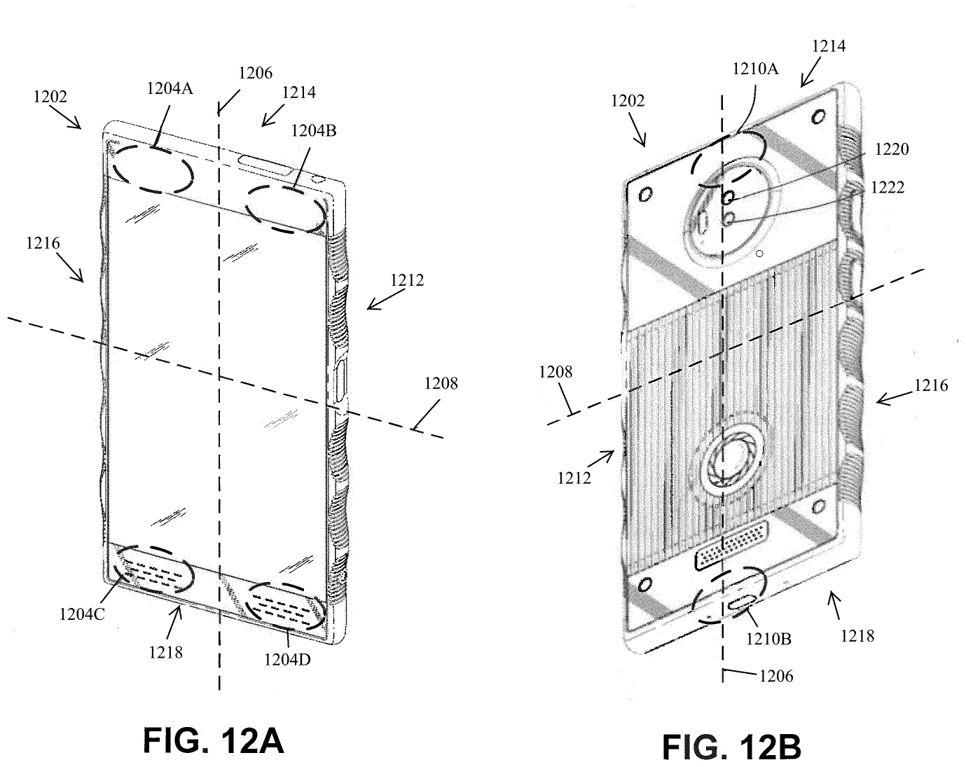

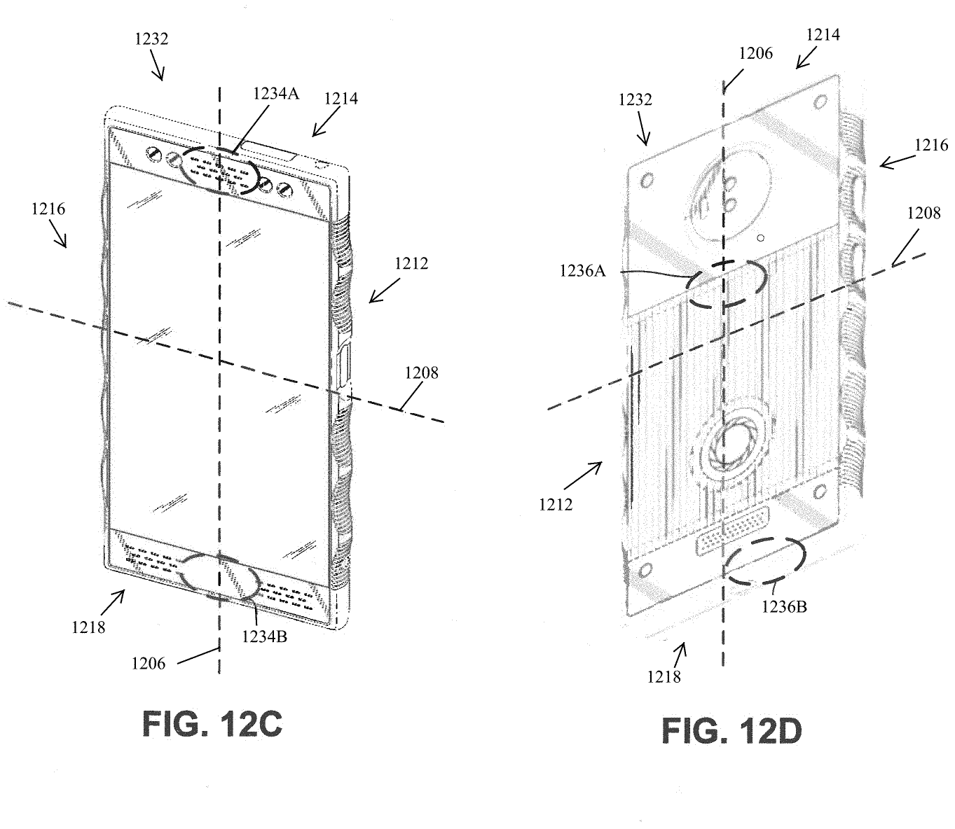

In other embodiments, there may be 3, 4, 8, or more microphones 230. An audio rendering unit 235 may access the recorded audio file from the memory 227, such as during video playback, where image data and audio data are retrieved in parallel by the audio rendering unit 235 and the video rendering unit 229 to playback the video. The audio rendering unit 235 implements a surround processing technique in some embodiments that creates a spatialized audio output, which causes the listener to distinguish sounds as coming from differently located sound sources. Techniques for creating a spatialized audio output stream are described in further detail herein, with respect to FIGS. 12-17.

In some implementations, the surround processing may be applied to any audio file, whether the audio file is locally stored on the phone 10 or streamed from an external or remote source. The surround effect may be processed in real-time or near-real-time such that the surround effect may be applied to the phone's 10 local speakers, a local headset or a wireless headset connected to the phone 10. When surround effect is enabled, the phone 10 may automatically activate the surround sound effect based on the type of the detected external output.

The audio rendering unit 235 may output the spatialized audio output stream to the audio output 234, which may include a plurality of integrated speakers, a wired headphone jack, or a wireless output (e.g., Bluetooth) for streaming to wireless speakers or headphones. The camera module 208 may include an image processing unit 240, which may implement any appropriate image processing on the video or still footage captured by the camera module 208. For instance, the video processing unit 224 may implement the compressed raw video processing described with respect to FIGS. 13-16, or some other image processing and/or compression techniques.

FIGS. 12A-12D illustrate examples of speaker and microphone arrangements for mobile devices according to certain embodiments. The microphones may be used to output stereo or multi-dimensional audio which may be processed according to any of the spatialization techniques described herein, and output by the speakers to provide an enriched surround sound experience. With such processing the mobile device may provide a user with the perception that audio is coming from particular directions or distances, thereby providing a full, rich, multi-dimensional surround sound experience.

FIG. 12A illustrates a front view of a mobile device 1202 having four speakers 1204A-1204D symmetrically arranged in the corners of the housing of the mobile device 1202. The speakers 1204A-1204D may be positioned beneath the front cover of the housing of the mobile device 1202 and be oriented to output sound in a direction substantially normal to the front surface of the housing, for example. As shown, in the illustrated embodiment the speakers 1204A, 1204B are symmetrically arranged with respect to one another about a longitudinal axis 1206 of the device 1202, and are symmetrically arranged with respect to the speakers 1204C, 1204D about a transverse axis 1208. The speakers 1204C, 1204D are symmetrically arranged with respect to one another about the longitudinal axis 1206. Such an arrangement may provide balanced audio output.

In some embodiments, the speakers are dedicated to output particular audio. For instance, in one embodiment, the speakers 1204A, 1204B are dedicated to output right channel audio, and the speakers 1204C, 1204D output left channel audio. In other embodiments, the mobile device 1202 may switch which output audio channel is output by which speaker depending on the orientation of the device 1202. For example, the mobile device 1202 may include one or more accelerometers or other sensors that may be used to determine whether the user is holding the device 1202 in a landscape or portrait orientation.

As one example, if the user is holding the device 1202 in a landscape orientation with the right side 1212 of the device 1202 pointed upwards, the speakers 1204A, 1204B may be used to output left channel audio of a stereo audio stream, and the speakers 1204C, 1204D may be used to output right channel audio, and vice versa (1204A, 1204B right channel, 1204C, 1204D left channel) if the left side 1216 is held upwards in a landscape orientation. On the other hand, if the device 1202 is being held in a vertical/portrait orientation with the top side 1214 of the device 1202 pointed upwards, the device 1202 may output left channel audio to the speakers 1204A, 1204C, and output right channel audio to the speakers 1204B, 1204D, and vice versa (1204A, 1204C right channel, 1204B, 1204D left channel) if the device 1202 is held with the bottom side 1218 upwards in a vertical/portrait orientation.

FIG. 12B a rear view of the mobile device 1202. As shown, the device 1202 includes two microphones 1210A-D, which are symmetrically disposed with respect to one another about the transverse axis 1208. The microphones 1210A-B in one implementation are placed beneath the rear surface of the housing of the mobile device 1202. The microphones 1210A, 1210B may be used to capture stereo audio content. For instance, if the device 1202 is held in a landscape orientation while recording with one or more of the rear cameras 1220, 1222 (or an attached camera module), with the right side 1212 upwards, the device 1202 uses the microphone 1210A to capture left channel audio, and the microphone 1210B to capture right channel audio, and vice versa (1210A right channel, 1210B left channel) if the device 1202 is held with the left side 1216 upwards. While not shown in FIG. 12B, in another embodiment, the phone may include two additional microphones. For instance, the two additional microphones may be placed symmetrically with respect to one another about the longitudinal axis 1206, and may be used to record left and right audio respectively when the phone is held in a portrait orientation. In another embodiment, there are microphones placed in the corners of the housing of the mobile device 1202 generally similar to the positioning of the speakers 1204A-1204D.

FIG. 12C illustrates speaker placement for another embodiment a mobile device 1232, including a first speaker 1234A positioned at the top of the housing of the mobile device 1232, roughly symmetrically about the longitudinal axis 1206, and a second speaker 1234B positioned at the bottom of the housing of the mobile device 1232, also roughly symmetrically about the longitudinal axis 1206. In some embodiments, one or both of the speakers 1234A, 1234B is positioned off-center to the left or right of the axis 1206. As shown, the speakers 1234A, 1234B are positioned on opposite sides of and generally equidistant from the transverse axis 1208. The device 1232 may output dedicated left channel audio to the speaker 1204A and dedicated right channel audio to the speaker 1204B. Or in another embodiment the device 1232 outputs left channel audio to the speaker 1204A and right channel audio to the speaker 1204B when the user is holding the device in a landscape orientation with the right side 1212 pointed upwards, and vice versa (1204A right channel, 1204B left channel) when the device is held with the left side 1216 pointed upwards.

FIG. 12D illustrates microphone placement for the mobile device 1232. As shown, the device 1232 includes a first microphone 1236A, which may be positioned within the housing and near the rear surface of the housing, and a second microphone 1236B positioned at the bottom side 1218 of the housing. The microphones 1236A, 1236B are positioned with sufficient physical separation from one another on opposite sides of the transverse axis 1208 to provide left and right channel separation during recording.

Some audio processing techniques that may be incorporated by embodiments of the mobile devices described herein are provided in U.S. Pat. Pub. No. 2014/0185844 entitled “Method for Processing an Audio Signal for Improved Restitution”, U.S. Pat. Pub. No. 2017/0215018 entitled “Transaural Synthesis Method for Sound Spatialization”, U.S. Pat. No. 9,609,454 entitled “Method for Playing Back the Sound of a Digital Audio Signal”, and International Publication No. WO 2018/185733 entitled “Sound Spatialization Method.”

Any of the mobile devices described herein may implement a sound spatialization technique, which may also be called spatialized rendering, of audio signals. In some embodiments, the mobile device may integrate a room effect using transaural techniques. For instance, one or more of the rendering unit 235 and audio processing unit 232 (FIG. 2) may implement any of the spatialization techniques described herein. The spatialized audio output may be referred to herein as spatialized audio, 3D audio, surround audio, or surround spatialized audio. The spatialized audio may be activated automatically by the phone 10 in certain embodiments according to a policy, which may be stored in a file on the phone 10.

For instance, in one embodiment, phone 10 only applies the spatialized rendering if the user is holding the phone 10 in a landscape mode, and outputs standard stereo or mono audio when the camera 10 is oriented in portrait mode. In other embodiments, the phone 10 applies the spatialized rendering in both landscape and portrait. For instance, the mobile device 1202 of FIG. 12A having the four symmetrically positioned speakers 1204A-1204D may be able to output spatialized audio regardless of the orientation of the device 1202.

The phone 10 may additionally determine whether or not to apply spatialized rendering by analyzing the data or metadata from the audio file, and comparing it to the stored policy. For instance, in some cases spatialized rendering is applied to media (e.g., audio from movies, music, or other on-line video content), but not to certain other audio, such as certain speech (e.g., speech during phone calls), FM radio streams, or Bluetooth Advanced Distribution Profile audio. The spatialized rendering may also be turned on and off manually by the user in some embodiments by adjusting the settings of the phone 10.

The spatialization techniques implemented by the mobile device may enrich the audio broadcast by the phone (e.g., wired or wirelessly to a pair of loudspeakers or headphones), in order to immerse a listener in a spatialized sound scene. The mobile device may apply the spatialized processing the audio to include a room effect or an outdoor effect. To apply binaural processing according to some embodiments, the phone 10 may apply a transfer function or impulse response on the source audio signal such as a “Head Related Transfer Function” (HRTF), or corresponding Head Related Impulse Response (HRIR). The mobile device may apply different HRTFs for each ear, e.g., on each corresponding audio channel. Such processing may give the user the feeling that sounds are coming from particular directions.

In addition to providing a directional sound effect, the mobile device may spatialize the sound to provide an effect that sounds are emanating from different distances from the user's ears (which may be referred to as providing externalization effect), despite the fact that the sounds are actually coming from a set of fixed speakers of the mobile device or headphones connected to the mobile device.

The mobile device may produce a spatialized stereo audio file from an original multichannel audio file, e.g., according to the techniques described in U.S. Patent Publication No. 2017/0215018. The mobile device can, for example, process a stereo signal of left and right channels, by processing the left and right channels with a different impulse response created respectively for each channel. The impulse responses may be pre-stored in the memory 227 (FIG. 2) of the mobile device 202, for example.

According to certain embodiments, the mobile device may apply spatialization processing based on one of a plurality of automatically or user selectable profiles, which may each correspond to a different physical spaces or soundscapes. For instance, each profile may store different impulse responses created for the different physical spaces or soundscapes. The profiles including the impulse responses may be pre-loaded in a database in the memory of the mobile device (e.g., the memory 200 of FIG. 2). The pre-loaded impulse responses may be acquired by detecting sound in a particular physical space by deconvolving sound acquired from a plurality of speakers arranged at particular locations, as is further described in U.S. Patent Publication No. 2017/0215018.

The mobile device may then create the spatialized stereo audio file or audio stream by applying the profile, e.g., by convolving the stereo audio file with the impulse responses. For example, referring to FIG. 2, the audio rendering unit 235 may obtain a stereo audio file from the memory 227 recorded by the microphones 230, and separate the audio into left and right channel audio streams. The audio rendering unit 235 may then access from the memory 227 a pre-loaded surround spatialization profile having left and right impulse responses, which correspond to a particular physical space type or soundscape.

For instance, the impulse responses may have been derived from sound detected in that physical space. The audio rendering unit 235 may apply convolution processing to the left and right channels using the left and right channel impulse responses, to calculate left and right channel spatialized stereo signals. The audio rendering unit 235 may then output the left and right spatialized signals to the audio output 234 (e.g., the speakers 1204A-1204D of FIG. 12A or the speakers 1234A, 1234B of FIG. 12B).

### Video Processing for Multi-View Displays

This disclosure describes, among other features, approaches for compressing video image data, such as raw Bayer data. The approaches desirably can, in certain embodiments, enable compression of the video image data using several lines of on-chip memory and without using a frame memory like DRAM. The compressed size of the video image data may be set and targeted for individual frames and adapted from frame-to-frame. Moreover, the approaches may provide a hardware-friendly implementation that enables a reduction in size and power consumption for devices which compress video image data. As a result, certain features of this disclosure may be particularly desirable for relatively smaller or low-power handheld devices, such as smart phones, where it may be desirable to save high quality video while limiting power consumption and system size. In some embodiments, such techniques may be used to compress fully-processed YUV data rather than raw.

FIG. 13A illustrates an image capture device 50 that may implement one or more of the compression techniques or other features described herein. The image capture device 50, in some embodiments, may be or incorporated as part of the phone 10, the camera module 30, or the video camera 40. The image capture device 50 may include a housing configured to support optics 51, an image sensor 52 (or multiple image sensors), an image processing system 53, a compression system 54, and a memory device 55. In some implementations, the image capture device 50 may further include a multimedia system 56. The image sensor 52, the image processing system 53, the compression system 54, and the multimedia system 56 may be contained within the housing during operation of the image capture device 50. The memory device 55 may be also contained or mounted within the housing, mounted external to the housing, or connected by wired or wireless communication external to the image capture device 50.

The optics 51 may be in the form of a lens system having at least one lens configured to focus an incoming image onto the image sensor 52. In some embodiments, the optics 51 may be in the form of a multi-lens system providing variable zoom, aperture, and focus. The optics 51 may be in the form of a lens socket supported by the housing and receive multiple different types of lens systems for example, but without limitation, the optics 51 may include a socket configured to receive various sizes of lens systems including a 50-100 millimeter (F2.8) zoom lens, an 18-50 millimeter (F2.8) zoom lens, a 300 millimeter (F2.8) lens, 15 millimeter (F2.8) lens, 25 millimeter (F1.9) lens, 35 millimeter (F1.9) lens, 50 millimeter (F1.9) lens, 85 millimeter (F1.9) lens, or any other lens. As noted above, the optics 51 may be configured such that images may be focused upon a light-sensitive surface of the image sensor 52 despite which lens is attached thereto. Additional information regarding such a lens system may be found in U.S. Pat. No. 9,568,808, the entire disclosure of which is included in the Appendix and herein incorporated by reference.

The image sensor 52 may be any type of video sensing device, including, for example, but without limitation, CCD, CMOS, vertically-stacked CMOS devices such as the Foveon® sensor, or a multi-sensor array using a prism to divide light between the sensors. The image sensor 52 may further include a color filter array such as a Bayer pattern filter that outputs data representing magnitudes of red, green, or blue light detected by individual photocells of the image sensor 52. In some embodiments, the image sensor 52 may include a CMOS device having about 12 million photocells. However, other size sensors may also be used. In some configurations, video camera 10 may be configured to output video at “2k” (e.g., 2048×1152 pixels), “4 k” (e.g., 4,096×2,540 pixels), “4.5 k,” “5 k,” “6 k,” “8 k”, “10 k”, 12 k”, or “16 k” or greater resolutions. As used herein, in the terms expressed in the format of “xk” (such as “2 k” and “4 k” noted above), the “x” quantity refers to the approximate horizontal resolution. As such, “4 k” resolution corresponds to about 4000 or more horizontal pixels and “2 k” corresponds to about 2000 or more pixels. Using currently commercially available hardware, the image sensor 52 may be as small as about 0.5 inches (8 mm), but it may be about 1.0 inches, or larger. Additionally, the image sensor 52 may provide variable resolution by selectively outputting only a predetermined portion of the image sensor 52. For example, the image sensor 52 or the image processing system 53 may be configured to allow a user to identify, configure, select, or define the resolution of the video data output. Additional information regarding sensors and outputs from sensors may be found in U.S. Pat. No. 8,174,560, the entire disclosure of which is included in the Appendix and herein incorporated by reference.

The image processing system 53 may format the data stream from the image sensor 52. The image processing system 53, for instance, may separate the green, red, and blue image data into three or four separate data compilations. For example, the image processing system 53 may be configured to separate the red data into one red channel or data structure, the blue data into one blue channel or data structure, and the green data into one green channel or data structure. The image processing system 53 may also separate the green into two separate green data structures in order to preserve the disparity between the diagonally adjacent green pixels in a 2×2 Bayer pattern. The image processing system 53 may process the picture element values to combine, subtract, multiply, divide, or otherwise modify the picture elements to generate a digital representation of the image data.

The image processing system 53 may further include a subsampling system configured to output reduced or unreduced resolution image data to multimedia system 56. For example, such a subsampling system may be configured to output image data to support 6K, 4K, 2K, 1080p, 720p, or any other resolution. Additionally, the image processing system 53 may include other modules or perform other processes, such as gamma correction processes, noise filtering processes, and the like.

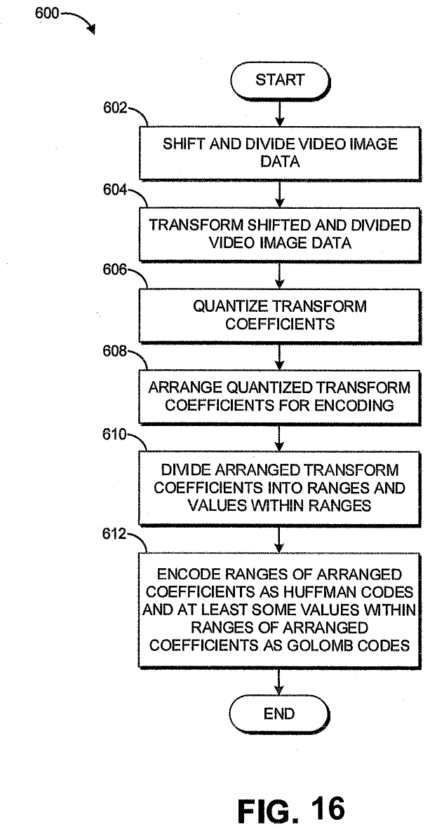

The compression system 54 may compress the image data from the image processing system 53 using a compression technique, such as the compression approach described with respect to FIG. 16, or another technique. The compression system 54 may be in the form of a separate chip or chips (for example, FPGA, ASIC, etc.). The compression system 54 may be implemented with software and another processor or may be implemented with a combination of processors, software, or dedicated chips. For example, the compression system 54 may include one or more compression chips that perform a compression technique in accordance with DCT-based codecs.

The compression system 54 may compress the image data from the image processing system 53 using DCT-based codecs with rate control. In some embodiments, the compression system 54 performs a compression technique that modifies or updates compression parameters during compression of video data. The modified or updated compression parameters may be configured to achieve targeted or desired file sizes, video quality, video bit rates, or any combination of these. In some embodiments, the compression system 54 may be configured to allow a user or other system to adjust compression parameters to modify the quality or size of the compressed video output by the compression system 54. For example, the image capture device 50 may include a user interface (not shown) that allows a user to input commands that cause the compression system 54 to change compression parameters.

The compression system 54 may compress the image data from the image processing system 53 in real time. The compression system 54 may perform compression using a single-pass to compress video frames. This may be used to eliminate the use of an intermediate frame memory used in some compression systems to perform multiple compression passes or to compress a current video frame based on the content from one or more previous video frames stored in an intermediate frame memory. This may reduce the cost or complexity of a video camera with on-board video compression. The compression system 54 may compress image data from the image processing system 53 in real time when the frame rate of the image data is at least 23 frames per second (fps), at least about 24 fps (e.g., 23.976 fps), at least about 25 fps, at least about 30 fps (e.g., 29.97 fps), at least about 48 fps, at least about 50 fps, at least about 60 fps (e.g., 59.94 fps), at least about 120 fps, at least about 240 fps, or less than or equal to about 240 fps. The compressed video may then be sent to the memory device 55.

The memory device 55 may be in the form of any type of digital storage, such as, for example, but without limitation, hard disks, flash memory, or any other type of memory. In some embodiments, the size of the memory device 55 may be sufficiently large to store image data from the compression system 54 corresponding to at least about 30 minutes of video at 12 megapixel resolution, 12-bit color resolution, and at 60 fps. However, the memory device 55 may have any size.

In embodiments that include the multimedia system 56, the multimedia system 56 may allow a user to view video images captured by the image sensor 52 during operation or video images received from the compression system 54 or the memory device 55. In some implementations, the image processing system 53 may include a subsampling system configured to output reduced resolution image data to the monitor system 56. For example, such a subsampling system may be configured to output video image data to support “2 k,” 1080p, 720p, or any other resolution. Filters used for de-mosaicing may also be adapted to perform down-sampling filtering, such that down-sampling and filtering may be performed at the same time. The multimedia system 56 may perform any type of decompression or de-mosaicing process to the data from the image processing system 53. For example, the multimedia system 56 may decompress data that has been compressed as described herein. Thereafter, the multimedia system 56 may output a de-mosaiced or decompressed image data to a display of the multimedia system 56 or another display.

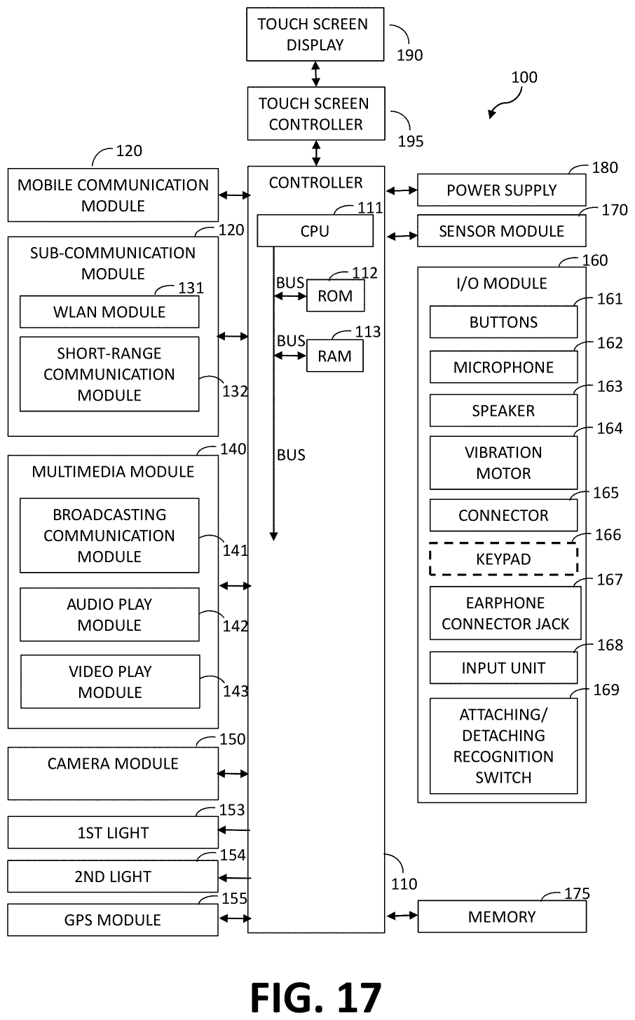

FIG. 13B illustrates additional components of the image capture device 50 according to some embodiments. FIG. 13B, in particular, depicts more implementation details of an embodiment of the image capture device 50 than FIG. 13A. As illustrated, the image capture device 50 is further in communication with frame memory 63. The frame memory 63 may be DRAM, such as the RAM 113 of FIG. 17.

The image capture device 50 further includes an image processing unit 60. As shown, the image processing unit 60 may include the image processing system 53, the compression system 54, and on-chip memory 62. The on-chip memory can, for example, be SRAM. Some or all of the components of the image processing unit 60 may be dedicated to use for processing and storage of image data (for example, compressed raw video image data) captured by the image capture device 50, and may not be used for other purposes, such as for implementing telephone functionality associated with the image capture device 50.

The image processing unit 60 may include one or more integrated circuits, chips or chipsets which, depending on the implementation, may include an application specific integrated circuit (ASIC), a field programmable gate array (FPGA), a combination thereof, or the like. According to certain embodiments, the on-chip memory 62 may be located within the same device (for example, ASIC, FPGA, or other chip[s]) as other components of the image processing unit 60, such as the image processing system 23 and compression system 54. For instance, the image processing unit 60 may include an ASIC or FPGA which implements the image processing system 53, the compression system 54, and the on-chip memory 62. The on-chip memory 62 may therefore be referred to as an “on-chip” memory according to certain embodiments, whereas the frame memory 63 may be referred to as an “off-chip” memory.

As shown, the frame memory 63 may be implemented separate from the image processing unit 60 and may be a DRAM. For instance, in one embodiment, the frame memory 63 and image processing unit 60 are respectively an ASIC and FPGA implemented in separate packages and mounted on a common printed circuit board. The frame memory 63 may be used to concurrently store an entire image frame (for example, all or substantially all of the pixel data of one image frame) for processing purposes. For instance, the frame memory 63 may be used by the image processing system 53 for storing entire image frames during certain image processing steps, such as pixel defect correction or pixel pattern noise correction as a couple of examples.

While the frame memory 63 may be used for some such steps, according to certain embodiments, the image capture device 50 implements an image processing pipeline in which compressed raw video image data is processed without utilizing the frame memory 63 for the purposes of compression. For instance, the compression system 54 in some embodiments implements a DCT-based compression scheme, which may be any of those described herein, such as with respect to FIG. 16. Such a DCT-based compression scheme may be relatively lightweight in memory requirements, such that the compression system 61 may perform the compression utilizing the on-chip memory 62 and not the frame memory 63 or any other frame memory during compression.

Avoiding use of frame memory during compression may significantly reduce power consumption, and contrasts with certain other compression techniques which involve the use of a frame memory for motion vector calculations. For instance, according to certain DCT-based compression techniques described herein, the compression system 54 operates on a discrete section of a video image frame (for example, a section smaller than a full image frame) at any given time, discards the discrete section of the video image frame immediately after processing. For instance, in one embodiment, the compression system 54 operates on data for 32 horizontal lines of pixels at a time, and only utilizes an amount of storage in the on-chip memory 62 corresponding to 64 lines of pixel data for compression purposes (to hold image data for 32 lines of pixel data currently being compressed and to hold image data for the next 32 lines to be compressed).

Depending on the embodiment, power consumption may be reduced such that, according to various embodiments the image capture device 50 consumes less than about 15 or 20 W during operation, and in some embodiments consumes between about 10 W to 20 W, between about 10 W to 25 W, or between about 5 W to 25 W. For instance, according to some embodiments the imaging componentry of the image processing device 50 (for example, the camera-related componentry of the image processing device 50) consumes less than about 10 W or 15 W (for example, between about 4 W to 10 W or between about 6 W 10 W), whereas the remaining non-imaging componentry (for example, phone componentry, display componentry, etc.) consumes less than about 10W (for example, between about 3 W to 10 W or between about 5 W 10 W).

The compression techniques described herein may allow for enhanced decoding/decompression speeds. For instance, the DCT-based raw compression techniques may allow for enhanced decompression because DCT algorithms allow for use of highly parallelized mathematical operations during decompression, making efficient use of graphics processing units. Depending on the embodiment, the raw compression techniques described herein may allow for decompression of video image frames in less than or equal to about 1/23, 1/24, 1/25, or 1/120 seconds, which may allow for real-time decompression, depending on the frame rate.

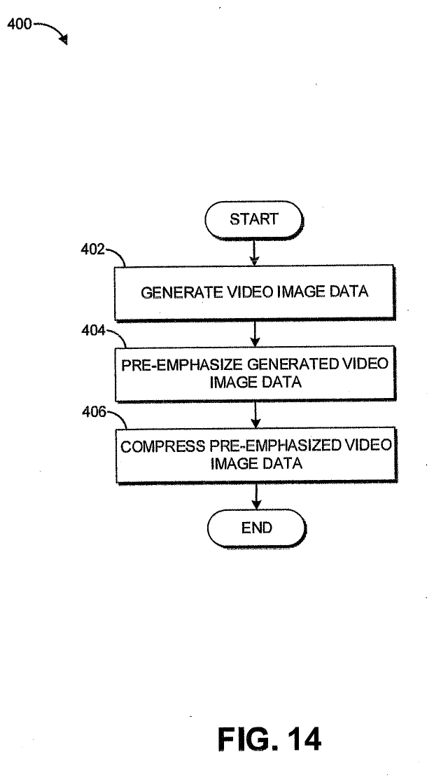

FIG. 14 is a flowchart 400 illustrating an example process for processing video image data that is performable by an image capture device, such as the phone 10, the camera module 30, the video camera 40, or the image capture device 50. The flowchart 400 may represent a control routine stored in a memory device, such as the memory device 55, the ROM 112, RAM 113, or memory 175. Additionally, a processor, such as the controller 110, may be configured to execute the control routine. For convenience, the flowchart 400 is described in the context of the image capture device 50 but may instead be implemented by other systems described herein or other appropriate computing systems not shown. The flowchart 400 advantageously, in certain embodiments, depicts an example approach by which a relatively small or low-power handheld device like a cellphone may process video image data.

At block 402, the image sensor 52 may generate video image data responsive to light incident on the image sensor 52. For example, the image sensor 52 may generate the video image data as raw mosaiced image data at least at about 23 frames per second and with a resolution of at least 2K. Moreover, the output from the one or more image sensors 202 may in some implementations each be at least 16-bit wide with 15-bit outputs and 1 bit set for black sun effect. The image sensor 52 can, in some instances, be used to generate 3D video image data for processing and eventual presentation as 3D video images.

At block 404, the image processing system 53 may pre-emphasize the video image data generated by the image sensor 52. The generated video image data may be pre-emphasized by performing a lossy transform to raw pixels of the generated video image data. The pre-emphasis may desirably, in certain embodiments, reduce an amount of video image data to be processed at block 406 while nonetheless preserving video image data quality.

The image processing system 53 can, for example, perform a piecewise linear function to that transforms the raw pixels from 15-bit or 16-bit data to 12-bit data. The slope of the piecewise linear function may follow a harmonic progression 1, ½, 1/15, 1/16 and change every 256 counts. The shape of the piecewise linear function may be tailored to the image sensor 52 from sensor characterization data and thus vary from sensor to sensor or sensor manufacturer to sensor manufacturer. The input range of the piecewise linear function may, in some instances, go above a maximum value permitted to account for a black offset that may be applied.

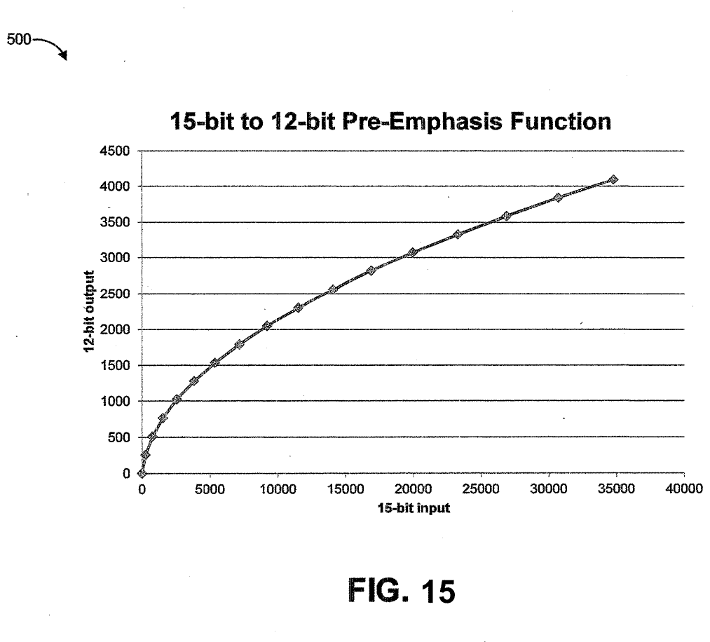

FIG. 15 is a plot 500 that graphically illustrates one example piecewise linear function for transforming raw pixels from 15-bit data to 12-bit data. Table 1 below provides example points along the plot 500.

TABLE 1

| 15-bit input | 12-bit output |
|---|---|
| 0 | 0 |
| 256 | 256 |
| 768 | 512 |
| 1536 | 768 |
| 2560 | 1024 |
| 3840 | 1280 |
| 5376 | 1536 |
| 7168 | 1792 |
| 9216 | 2048 |
| 11520 | 2304 |
| 14080 | 2560 |
| 16896 | 2816 |
| 19968 | 3072 |
| 23296 | 3328 |
| 26880 | 3584 |
| 30720 | 3840 |
| 34800 | 4095 |

The pre-emphasis may be performed by the image processing system 53 given the understanding that not all video image data values in a bit range (such as a 15-bit range including 0-32767) carry the same information. Incoming light at each pixel may be governed by a Poisson process that results in a different photon shot noise (PSN) at each light level. The Poisson random distribution may have a unique characteristic where a variance of a distribution is equal to a mean of the distribution. Thereby, the standard deviation is equal to the square root of the mean. From this understanding, the uncertainty (such as indicated by the standard deviation) associated with each measured digital number output (DN), corresponding to incoming light for a particular pixel, may be proportional to \sqrt{DN}. To pre-emphasize, one or more digital values in an input domain may be lumped to a single digital value in an output domain. If Q adjacent DN values are lumped together (for instance, quantized) into one, the resulting noise may be proportional to \sqrt{Q³}. The quantization noise may be minimized by choosing Q such that \sqrt{DN} α \sqrt{Q³} (for example, Qα³ \sqrt{DN}). The complexity of this function may be reduced by constructing a piecewise linear function from the function. Using this technique, additional noise added by the pre-emphasis may be reduced, such as to a small percentage (like 1% of the photon shot noise in an example worst case scenario).

A conversion function may be used to convert pre-emphasized values after decoding. For example, the following function, which is expressed in pseudocode, may be used to convert 12-bit data back to 15-bit data after decoding.

int index=imageData[i][j]>>8;

int offset=imageData[i][j] & 0xff;

int value=(index+1)*offset+((index+1)*index*128)+((index+1)>>1);

In some instances, using a conversion function (sometimes referred to as a pre-emphasis function) that has a relatively simple inverse may helpful for decoding compressed image in hardware using parallel processing. For example, when an example conversion function has a relatively simple inverse, a Graphical Processing Unit (GPU) may be used to relatively quickly convert 12-bit data back to its original 15-bit data form after decompression. Additional information regarding pre-emphasis techniques may be found in U.S. Pat. No. 8,174,560, the entire disclosure of which is included in the Appendix and herein incorporated by reference.

At block 406, the compression system 54 may compress the video image data pre-emphasized by the image processing system 53. For example, the compression system 54 may compress the pre-emphasized video image data as described with respect to FIG. 16 or using another compression algorithm. The compression system 54 can, in some implementations, perform one or more of the following: (i) compress the video image data without using a frame memory that stores a full image frame, (ii) compress the video image data using one memory device and without using any memory positioned off-chip relative to the one memory device, (iii) compress the video image data using a static memory that may not be periodically refreshed rather than a dynamic memory that must be periodically refreshed, and (iv) operate according to the timing of a clock and correctly compress the video image data despite the clock stopping for a period of time such as a 5, 10, 20, or 30 seconds or 1, 2, 3, 5, or 10 minutes. The compression system 54 moreover may be used to compress video image data that is presentable as 3D video images.

FIG. 16 is a flowchart 600 illustrating an example process for compressing video image data that is performable by an image capture device, such as the phone 10, the camera module 30, the video camera 40, or the image capture device 50. The flowchart 600 may represent a control routine stored in a memory device, such as the memory device 55, the ROM 112, RAM 113, or memory 175. Additionally, a processor, such as the controller 110, may be configured to execute the control routine. For convenience, the flowchart 600 is described in the context of the image capture device 50 but may instead be implemented by other systems described herein or other appropriate computing systems not shown. The flowchart 600 advantageously, in certain embodiments, depicts an example approach by which a relatively small or low-power handheld device like a cellphone may compress video image data.

At block 602, the compression system 54 may shift and divide video image data. Values of the video image data may be shifted by an amount equal to a central value for the video image data that depends on a number of bits of the data (for instance, the central value may be 0.5·2ⁿ for n-bit data, which means 2048 in the case of 12-bit data). The shifting may shift the values around a value of 0 for further processing. The values may also be divided into slices and macroblocks. In one implementation, a maximum size of the slice is 256×32 pixels, and maximum size slices are packed from left to right. If some pixels are still left on the end of each line, a slice of size 256×32 pixels, 128×32 pixels, 64×32 pixels, 32×32 pixels, or another size may be made by packing pixels of value 0 at the end. In instances where the pixels follow a Bayer pattern, each slice may have 128×16 Green1, Green2, Red, and Blue pixels, and the pixels may be further divided into 8 macroblocks (16×16 pixels) of Green1, Green2, Red, and Blue pixels.

At block 604, the compression system 54 may transform the shifted and divided video image data, such as using a discrete cosine transform (DCT) or another transform. In one example, the compression system 54 may transform each macroblock of the shifted and divided video image data using a 16×16 DCT. The 16×16 DCT notably may provide, in some instances, higher compression efficiency than an 8×8 DCT. The two dimensional 16×16 DCT may moreover be separable into 32 one dimensional 1×16 DCT calculations. This separability advantageously can, in certain embodiments, facilitate the use of memory having a capacity less than a frame memory (for example, multiple lines of on-chip memory 62) when performing compression. The output from the transformation may be transform coefficients for the video image data.

At block 606, the compression system 54 may quantize the transform coefficients. The quantization may include two components. The first component may be a quantization table value from one or more quantization tables. For example, one quantization table may be used for Green1 and Green2 channels, and another quantization table may be used for blue and red channels. The one or more quantization tables may be defined in a frame header. The second component may be a quantization scale factor. The quantization scale factor may be the same for each value within a slice, vary from a minimum value (for example, 1) to a maximum value (for example, 255), be defined in a slice header, and used for achieving a target slice size. The quantization scale factor may be determined based at least on a target frame size or a technique such as that provided in further detail herein. The quantization scale factor may be set constant in some instances to generate a compressed video of certain quality irrespective of the compressed image size. In one implementation, the quantized values for the transform coefficients may be determined using Equation 1 below.

$$Quantized value = \frac{Transformes Coefficient Value}{\begin{matrix}Quantization Table Value * \\ Quantization Scale Factor\end{matrix}} \qquad Equation 1$$

At block 608, the compression system 54 may arrange the quantized transform coefficients slice-by-slice for encoding and so that green, red, and blue components may be encoded separately within a slice. The DC coefficients of the macroblocks of one slice may be arranged left to right. The AC coefficients of the macroblocks of the one slice may arranged so that (i) all particular location AC coefficients in a 16×16 DCT table from different macroblocks in the slice are arranged one after the other and (ii) the different AC coefficients are arranged by the zig-zag scan order illustrated by Table 2 below where the index in Table 2 indicates a position in the sequence for the quantized transform coefficients.

TABLE 2

| | | | | | | | | | | | | | | | |
|---|---|---|---|---|---|---|---|---|---|---|---|---|---|---|---|
| 0 | 1 | 5 | 6 | 14 | 15 | 27 | 28 | 44 | 45 | 65 | 66 | 90 | 91 | 119 | 120 |
| 2 | 4 | 7 | 13 | 16 | 26 | 29 | 43 | 46 | 64 | 67 | 89 | 92 | 118 | 121 | 150 |
| 3 | 8 | 12 | 17 | 25 | 30 | 42 | 47 | 63 | 68 | 88 | 93 | 117 | 122 | 149 | 151 |
| 9 | 11 | 18 | 24 | 31 | 41 | 48 | 62 | 69 | 87 | 94 | 116 | 123 | 148 | 152 | 177 |
| 10 | 19 | 23 | 32 | 40 | 49 | 61 | 70 | 86 | 95 | 115 | 124 | 147 | 153 | 176 | 178 |
| 20 | 22 | 33 | 39 | 50 | 60 | 71 | 85 | 96 | 114 | 125 | 146 | 154 | 175 | 179 | 200 |
| 21 | 34 | 38 | 51 | 59 | 72 | 84 | 97 | 113 | 126 | 145 | 155 | 174 | 180 | 199 | 201 |
| 35 | 37 | 52 | 58 | 73 | 83 | 98 | 112 | 127 | 144 | 156 | 173 | 181 | 198 | 202 | 219 |
| 36 | 53 | 57 | 74 | 82 | 99 | 111 | 128 | 143 | 157 | 172 | 182 | 197 | 203 | 218 | 220 |
| 54 | 56 | 75 | 81 | 100 | 110 | 129 | 142 | 158 | 171 | 183 | 196 | 204 | 217 | 221 | 234 |
| 55 | 76 | 80 | 101 | 109 | 130 | 141 | 159 | 170 | 184 | 195 | 205 | 216 | 222 | 233 | 235 |
| 77 | 79 | 102 | 108 | 131 | 140 | 160 | 169 | 185 | 194 | 206 | 215 | 223 | 232 | 236 | 245 |
| 78 | 103 | 107 | 132 | 139 | 161 | 168 | 186 | 193 | 207 | 214 | 224 | 231 | 237 | 244 | 246 |
| 104 | 106 | 133 | 138 | 162 | 167 | 187 | 192 | 208 | 213 | 225 | 230 | 238 | 243 | 247 | 252 |
| 105 | 134 | 137 | 163 | 166 | 188 | 191 | 209 | 212 | 226 | 229 | 239 | 242 | 248 | 251 | 253 |
| 135 | 136 | 164 | 165 | 189 | 190 | 210 | 211 | 227 | 228 | 240 | 241 | 249 | 250 | 254 | 255 |

At block 610, the compression system 54 may divide the arranged transform coefficients into ranges and values within ranges. The ranges for the DC coefficients may be ranges of possible values of the DC coefficients, and the ranges for the AC coefficients may be ranges of possible values of the AC coefficients and counts of groupings of 0 values.

At block 612, the compression system 54 may encode the ranges of the arranged coefficients as Huffman codes and at least some of the values within the ranges of the arranged coefficients as Golomb codes. If a range has no more than one unique value, the one unique value may be encoded with a Huffman code and not a Golomb code. If a range has more than one unique value, values may be encoded by a combination of a Huffman code for the range and a Golomb code for the unique value within the range. The ranges and the Golomb codes for the ranges may be fixed or predefined, such as set at manufacture. The Huffman codes for the ranges, however, may vary from frame to frame with one or more Huffman tables being defined in a frame header. An encoder may use the adaptability of Huffman coding and may compute one or more Huffman tables at the end of each frame to be used for a next frame to optimize compression efficiency for particular video image data. In one implementation, a maximum number of bits in a Huffman code may be 12.

The value of a DC coefficient of a particular component in a slice may be encoded as a difference from the previous value of the DC coefficient. This difference may be termed a difference coefficient. An initial value for the DC coefficient for the particular component in the slice may be set to 0. To encode the values of individual DC coefficients, the compression system 54, for example, may (i) calculate the absolute value of the difference coefficient for the individual DC coefficient, (ii) append the Huffman code corresponding to the range of the individual DC coefficient to the bit stream, (iii) append the Golomb code corresponding to the value within the range of the individual DC coefficient to the bit stream, and (iv) append a sign bit (for example, 0 for positive and 1 for negative) to the bitstream if difference coefficient is nonzero.

Table 3 below provides an example DC encoding table. The Huffman code portion of the table may be used as a default table at the beginning of compression when compression statistics may be unknown.

TABLE 3

| Example DC Huffman Table | | | |
|---|---|---|---|
| | Huffman | Huffman | |
| \|DC Value\| | Code | Bits | Golomb Code |
| 0-15 | 0 | 1 | Golomb-Rice(\|DC Value\|, 2) |
| 16-31 | 11 | 2 | Golomb-Rice(\|DC Value\| −16, 2) |
| 32-63 | 010 | 3 | Golomb-Rice(\|DC Value\| −32, 3) |
| 64-127 | 011 | 3 | Golomb-Rice(\|DC Value\| −64, 4) |
| 128-255 | 100 | 3 | Golomb-Rice(\|DC Value\| −128, 5) |
| 256-511 | 1010 | 4 | Golomb-Rice(\|DC Value\| −256, 6) |
| 512-inf | 1011 | 4 | ExpGolomb(\|DC Value\| −512, 7) |

For example, as may be seen from Table 3, if the difference coefficient may be 20, the Huffman code may be 11, the Huffman bits may be 2, the Golomb code may be Golomb-Rice(4, 2), and the sign bit may be 0. As another example, if the difference coefficient may be −75, the Huffman code may be 011, the Huffman bits may be 3, the Golomb code may be Golomb-Rice(11, 4), and the sign bit may be 1. As yet another example, if the difference coefficient may be 300, the Huffman code may be 1010, the Huffman bits may be 4, the Golomb code may be Golomb-Rice(44, 6), and the sign bit may be 0.

The values of AC coefficients may be represented by runs of zeros followed by a non-zero value. Different Huffman codes may denote the values of AC coefficients that are preceded by runs of zeros and those that are not preceded by runs of zeros. To encode the values of non-zero individual AC coefficients, the compression system 54, for example, may (i) calculate EACV=|AC value|−1 for the individual AC coefficient, (ii) determine whether the individual AC coefficient is preceded by one or more zeros, (iii) append the Huffman code corresponding to the EACV for the individual DC coefficient to the bit stream, (iv) append the Golomb code corresponding to the EACV to the bit stream if EACV exceeds 3, and (v) append a sign bit (for example, 0 for positive and 1 for negative) to the bitstream. Moreover, to encode the values of individual AC coefficients that have values of zero, the compression system 54, for example, may (i) calculate EACR=AC runs of zeros−1, (ii) append the Huffman code corresponding to the EACR to the bit stream, and (iii) append the Golomb code corresponding to the EACR to the bit stream if EACR exceeds 3.

Table 4 below provides an example AC encoding table. The Huffman code portion of the table may be used as a default table at the beginning of compression when compression statistics may be unknown.

TABLE 4
Example AC Huffman Table

| AC Value after zero AC Run | | | AC Value after non-zero AC Run | | | AC Run Length | | | |
|---|---|---|---|---|---|---|---|---|---|
| \|AC | Huffman | Huffman | | Huffman | Huffman | AC | Huffman | Huffman | |
| Value\| −1 | Code | Bits | \|AC Value\| −1 | Code | Bits | Run −1 | Code | Bits | Golomb Code |
| 0 | 01 | 2 | 0 | 10 | 2 | 0 | 1 | 1 | |
| 1 | 110 | 3 | 1 | 1111 | 4 | 1 | 001 | 3 | |
| 2 | 0010 | 4 | 2 | 000011 | 6 | 2 | 0100 | 4 | |
| 3 | 00000 | 5 | 3 | 0011000 | 7 | 3 | 0101 | 4 | |
| 4-7 | 0001 | 4 | 4-7 | 001101 | 6 | 4-7 | 011 | 3 | Golomb-Rice (\|AC Value\|−4, 0) |
| 8-15 | 1110 | 4 | 8-15 | 0011001 | 7 | 8-15 | 0001 | 4 | Golomb-Rice (\|AC Value\|−8, 1) |
| 16-31 | 00111 | 5 | 16-31 | 000010110 | 9 | 16-31 | 00001 | 5 | Golomb-Rice (\|AC Value\|−16, 2) |
| 32-63 | 0000100 | 7 | 32-63 | 0000101110 | 10 | 32-63 | 000000 | 6 | Golomb-Rice (\|AC Value\|−32, 3) |
| 64-inf | 00001010 | 8 | 64-inf | 0000101111 | 10 | 64-inf | 000001 | 6 | ExpGolomb (\|AC Value\|−64, 4) |

To illustrate how Table 4 may be used for encoding, an example of encoding the eleven coefficient sequence of 0, 2, 0, 0, −10, 50, 0, 0, 0, 0, and 0 will be described. As may be seen from Table 4, for the run of one zero, the “AC Run−1” may be 0, the Huffman code may be 1, the Huffman bits may be 1, and there may be no Golomb code. Next, for the value of 2 which is preceded by the run of at least one zero, the “|AC Value|−1” may be 1, the Huffman code may be 1111, the Huffman bits may be 4, there may be no Golomb code, and the sign bit may be 0. Subsequently, for the run of two zeros, the “AC Run−1” may be 1, the Huffman code may be 001, the Huffman bits may be 3, and there may be no Golomb code. Then next, for the value of −10 which is preceded by the run of at least one zero, the “|AC Value|−1” may be 9, the Huffman code may be 0011001, the Huffman bits may be 7, the Golomb code may be Golomb-Rice(2, 1), and the sign bit may be 1. Then subsequently, for the value of 50 which is not preceded by a run of at least one zero, the “|AC Value|−1” may be 49, the Huffman code may be 0000100, the Huffman bits may be 7, the Golomb code may be Golomb-Rice(18, 3), and the sign bit may be 0. Finally, for the remaining run of five zeros, the “AC Run−1” may be 4, the Huffman code may be 011, the Huffman bits may be 3, and the Golomb code may be Golomb-Rice(1, 0).

As further part of the process of the flowchart 600, adaptive compression may be performed in certain implementations. For example, a size of a compressed frame may be set close to a target number of bytes. An entropy index for each slice may moreover be calculated. The entropy index along with an entropy multiplier may be used to calculate the quantization scale factor. The range of DCT 16×16 may notably be higher than that of DCT 8×8 for the same 12-bit input. In some instances, because 32 lines of raw image data may be processed at a time, an image may be divided vertically (or otherwise) into 8 or more sections. After processing individual sections, a size of the compressed image thus far may be available. The size of the compressed image may then be used to update an entropy multiplier. At the end of frame compression, the size of the compressed image may be compared to a target size to further update the entropy multiplier.

Although some examples herein describe coding ranges or values within ranges using Huffman codes (or algorithms) and Golomb codes (or algorithms), other codes (or algorithms) may be used. For example, a lossless code, a lossy code, a variable length code, or a prefix code may be used. In some embodiments, a first algorithm may be used for coding ranges and a second algorithm may be used for coding values within ranges. The first algorithm can, in some instances, be different from the second algorithm so that ranges and values within ranges may be coded differently. In other instances, the first algorithm may be the same as the second algorithm.

### Video Stream Specification

Video image data, which may be compressed using one or more approaches disclosed herein, may be organized according to a video stream specification. The video stream specification can, in some implementations, include one or more of the following features.

A frame structure in a compressed file may be divided into header and data portions. The header may be designed to be hardware friendly. In some instances, all values in the header other than the size of a compressed frame may be known before the compression begins. A header version may be used to decode the compressed file, such as for playback on-camera or off-camera, if revisions were made to the file format. The header can, for instance, contain 600 bytes. The header may be followed by slices ordered left to right and top to bottom. Each slice may contain an integer number of bytes. One example header structure is shown below in Table 5.

TABLE 5
Frame Header

| Begin Location | Bytes | Description |
|---|---|---|
| 0 | 8 | Number of bytes in compressed frame |
| 8 | 1 | Header: Major Version |
| 9 | 1 | Header: Minor Version |
| 10 | 2 | Horizontal Size |
| 12 | 2 | Veritical Size |
| 14 | 1 | Macroblocks per slice |
| 15 | 1 | Chroma Format 0 --> 422 1 --> 444 |
| 16 | 2 | Number of slices per Frame |
| 18 | 2 | Reserved - Set to 0 |
| 20 | 256 | Luma Quantization Table |
| 276 | 256 | Chroma Quantization Table |
| 532 | 14 | DC Huffman Table |
| 546 | 18 | AC Value zero run Huffman table |
| 564 | 18 | AC Value non-zero run Huffman table |
| 582 | 18 | AC run length Huffman table |

Individual entries in a Huffman table may be 2 bytes (16-bits) wide. As illustrated by Table 6 below, the most significant bits (for example, first 4 bits) of a Huffman table structure may represent a size of the Huffman code, and the least significant bits (for example, last 12 bits) of the Huffman table structure may represent the Huffman code itself that may be aligned to the right and left padded with zeros.

TABLE 6

| | |
|---|---|
| Code Size (4 bits) | Huffman Code (12 bits) |

Each slice may have a header (for example, 9 bytes) followed by Green1, Green2, Red, and Blue components. Each component may begin on a byte boundary. If a component may have fractional bytes, the component may be padded with zeros to form a complete byte. Table 7 below illustrates an example slice structure.

TABLE 7

| | | | | |
|---|---|---|---|---|
| Slice Header | Green1 Data | Green2 Data | Red Data | Blue Data |
| (9 bytes) | (Variable) | (Variable) | (Variable) | (Variable) |

Table 8 below shows an example slice header structure. The number of bits of the slice header structure may be specified to avoid confusing padded bits with Huffman codes of value zero. If the number of bits in a component may not be a multiple of 8, a next component may begin on a byte boundary.

TABLE 8
Slice Header

| Begin Location | Bytes | Description |
|---|---|---|
| 0 | 1 | Quantization Scale Factor |
| 1 | 2 | Number of bits in G1 Stream |
| 3 | 2 | Number of bits in G2 Stream |
| 5 | 2 | Number of bits in B Stream |
| 7 | 2 | Number of bits in R Stream |

Various embodiments described herein relate to image capture devices capable of capture and on-board storage of compressed raw (for example, mosaiced according to a Bayer pattern color filter array or according to another type of color filter array), high resolution (for example, at least 2 k, 4 k, 6 k, 8 k, 10 k, 12 k, 15 k, or ranges of values between any of these resolution levels) video image data. The compressed raw image data may be “raw” in the sense that the video data is not “developed”, such that certain image processing image development steps are not performed on the image data prior to compression and storage. Such steps may include one or more of interpolation (for example, de-Bayering or other de-mosaicing), color processing, tonal processing, white balance, and gamma correction. For example, the compressed raw image data may be one or more of mosaiced (for example, not color interpolated, not demosaiced), not color processed, not tonally processed, not white balanced, and not gamma corrected. Rather, such steps may be deferred for after storage, such as for off-board post-processing, thereby preserving creative flexibility instead of than “baking in” particular processing decisions in camera.

The image processing and compression techniques described herein may be implemented in a variety of form factors. For instance, the techniques described herein for compressing and on-board storage of compressed raw image data may be implemented in a relatively small-form factor device, such as a smart phone having an integrated camera (or multiple cameras including front camera(s) and rear camera(s), or a small form factor camera. For instance, the processing techniques according to certain embodiments are tailored for implementation in a small form factor device having relatively limited power budget, processing capability, and physical real estate for incorporation of electronic components, etc. In another example, the compression techniques described herein may be implemented in relatively larger form factor cameras, including digital cinema cameras. According to certain aspects, an image capture device may be configured to capture raw mosaiced image data, compress the raw image data, and store the image data in on-board memory of the image capture device.

Electronics residing of the image capture device may be configured to, as part of the compression, transform the raw mosaiced image data using a discrete cosine transform (DCT) or another transform (such as a transform that defines a finite sequence of data points in terms of a sum of functions oscillating at different frequencies) to obtain transform coefficients, and compress the transform coefficients. According to some embodiments, the electronics may be configured to perform the compression without using an image frame memory (for example, a dynamic random access memory [DRAM]) that stores a full image frame for processing purposes. For instance, the electronics may compress the transform coefficients using an on-chip first memory (for example, a static random-access memory [SRAM]) that is integrated with an image processing chip (for example, an application specific integrated circuit [ASIC] or field-programmable gate array (FPGA]), and without using any second DRAM or other memory positioned off-chip.

In certain embodiments, the electronics may nonetheless include a DRAM or other second memory off-chip. However, the off-chip memory in such embodiments may used for purposes other than compression of raw video image data, such as for pixel defect correction, addressing pixel pattern noise, or the like. This is unlike existing image capture devices, such as smart phones, which use an off-chip DRAM to perform image compression. For instance, some existing image capture devices use an off-chip DRAM to calculate motion vectors for H.264 compression. Certain embodiments described herein use DCT techniques, thereby facilitating memory-efficient compression, without the need to calculate motion vectors or use off-chip memory.

Performing compression without use of a full image frame memory (for example, an off-chip DRAM) enhances power efficiency (such as, by around 0.5 Watts (W) in some implementations), which is particularly useful in a small-form factor device such as a smart phone. According to certain aspects, the electronics of the image capture device consume less than 15 W or less than about 20 W during operation. Features disclosed herein can, in certain embodiments, provide approaches for decoding as much of a frame as possible in real time and may enable decompression at a rate faster than 24 frames per second (fps). Moreover, the approaches can, in some implementations, make extensive use of a Graphical Processing Unit (GPU) of an electronic device and permit significant parallelization of operations while enabling a high image quality to be maintained.

According to some aspects, the image capture device includes a clock configured to control a timing at which the raw mosaiced image data is processed (for instance, compressed) by electronic circuitry, and the electronic circuitry is configured to correctly process the raw mosaiced image data despite the clock stopping for a period of time. This may be at least because the raw mosaiced image data may be processed by the electronic circuitry using memory that may not require refreshing.

According to certain aspects, the image capture device is configured to transform raw mosaiced image data to obtain transform coefficients. The device quantizes the transform coefficients to obtain quantized coefficients, and encodes at least some of the quantized coefficients by performing one or more of the following: dividing each quantized coefficient into a plurality of ranges and values within the plurality of ranges; determining a Huffman code for each quantized coefficient according to an individual range in which each quantized coefficient is included; and determining a Golomb code for each quantized coefficient according to an individual value within the individual range in which each quantized coefficient is included.

In some embodiments, an electronic device is disclosed. The electronic device includes a housing, an image sensor, a memory device, and one or more processors. The image sensor may generate image data from light incident on the image sensor. The one or more processors can: transform the image data to obtain transform coefficients, quantize the transform coefficients to obtain quantized transform coefficients including a first quantized transform coefficient and a second quantized transform coefficient different from the first quantized transform coefficient, encode the quantized transform coefficients to obtain encoded coefficients, and store the encoded coefficients to the memory device. The quantized transform coefficients may be encoded at least by: determining a first range of a plurality of ranges in which the first quantized transform coefficient is included, determining a second range of the plurality of ranges in which the second quantized transform coefficient is included, determining a first value within the first range to which the first quantized transform coefficient corresponds, determining a second value within the second range to which the second quantized transform coefficient corresponds, encoding, using a first algorithm, the first range as a first range code and the second range as a second range code, and encoding, using a second algorithm different from the first algorithm, the first value as a first value code and the second value as a second value code. The encoded coefficients may include the first range code, the second range code, the first value code, and the second value code.

The electronic device of the preceding paragraph may include one or more of the following features: The first algorithm is a Huffman code, or the second algorithm is a Golomb code. The one or more processors may vary the first algorithm during processing of the image data. The one or more processors may vary the first algorithm from processing a first frame of the image data to processing a second frame of the image data. The second algorithm may remain constant during processing of the image data by the one or more processors. The quantized transform coefficients may include a third quantized transform coefficient different from the first quantized transform coefficient and the second quantized transform coefficient, and the one or more processors may encode the quantized transform coefficients by at least: determining a third range of a plurality of ranges in which the third quantized transform coefficient is included, not determining a third value within the third range to which the third quantized transform coefficient corresponds, and encoding, using the first algorithm, the third range as a third range code, the encoded coefficients comprising the third range code.

The one or more processors may transform the image data using a discrete cosine transform. The discrete cosine transform may be a 16×16 discrete cosine transform. The one or more processors may encode the quantized transform coefficients at least by encoding DC coefficients of the quantized transform coefficients differently from AC coefficients of the quantized transform coefficients. The one or more processors may store a parameter for the first algorithm in a frame header for the encoded coefficients. The one or more processors may quantize the transform coefficients by at least using a first quantization table for green pixels of the image data and a second quantization table for red pixels and blue pixels of the image data, the first quantization table being different from the second quantization table. The image data may be moasiced image data. The image data may be raw moasiced image data. The housing may be a mobile phone housing, and the mobile phone housing may support the image sensor, the memory device, and the one or more processors. The housing may enclose the image sensor, the memory device, and the one or more processors, and the housing may removably attach to a mobile phone. The electronic device may further include a display configured to present holographic images generated by the one or more processors from the image data.

In some embodiments, a method of coding image data using an electronic device is disclosed. The method may include: generating, by an image sensor, image data from light incident on an image sensor; transforming, by one or more processors, the image data to obtain transform coefficients; quantizing, by the one or more processors, the transform coefficients to obtain quantized transform coefficients including a first quantized transform coefficient and a second quantized transform coefficient different from the first quantized transform coefficient; determining, by the one or more processors, a first range of a plurality of ranges that includes the first quantized transform coefficient and a second range of the plurality of ranges that includes the second quantized transform coefficient; determining, by the one or more processors, a first value within the first range that corresponds to the first quantized transform coefficient and a second value within the second range that corresponds to the second quantized transform coefficient; encoding, by the one or more processors, the first range as a first range code and the second range as a second range code; encoding, by the one or more processors, the first value as a first value code and the second value as a second value code; and storing the first range code, the second range code, the first value code, and the second value code to the memory device.

The method of the preceding paragraph may include one or more of the following features: The encoding the first and second ranges and the encoding the first and second values may be performed using lossless compression. The encoding the first and second ranges and the encoding the first and second values may be performed using variable length coding. The method may further include: retrieving the first range code, the second range code, the first value code, and the second value code from the memory device; and decoding, by the one or more processors, the first range code, the second range code, the first value code, and the second value code to obtain the first range, the second range, the first value, and the second value. The first range and the second range may be encoded as the first range code and the second range code using a Huffman code, or the first value and the second value may be encoded as the first value code and the second value code using a Golomb code. The transforming the image data may be performed using a 16×16 discrete cosine transform.

While certain embodiments are described with respect to specific resolutions (for example, at least 2 k or at least 4 k) or frame rates (for example, at least 23 frames per second), such embodiments are not limited to those frame rates or resolution levels. For instance, depending on the embodiment (for example, depending on sensor size) the techniques for on-board storage of compressed raw image data described herein may be capable of achieving resolution levels of at least 2 k, 3 k, 4 k, 4.5 k, 5 k, 6 k, 8 k, 10 k, 12 k, 15 k, 20 k, or greater resolution levels, or resolution levels between and inclusive of any of the foregoing resolution levels (for example, between and inclusive of 4 k and 12 k). Similarly, depending on the embodiment, the techniques for on-board storage of compressed raw image data described herein may be capable of capturing or storing image data at frame rates of at least 23, 24, 25, 120, 150, or 240 or greater fps, or of frame rates between and inclusive of any of the foregoing resolution levels (for example, between and inclusive of 23 fps and 120 fps).

Although Green1 and Green2 may be described as processed separately or differently in some instances herein, Green1 and Green2 may or may not be processed separately or differently. For example, Green1 and Green2 pixels may be separated into separate DCT macroblocks or may not be separated into separate DCT macroblocks. As another example, Green1 and Green2 pixels may be separated into separate scans or may not be separated into separate scans. In yet another example, a slice structure may have separate portions for Green1 and Green2 or may not have separate portions for Green1 and Green2. In a further example, Green1 and Green2 may have separate sizes in a slice header structure or may not have separate sizes in the slice header structure.

### Additional Embodiments and Terminology

FIG. 17 illustrates components of the phone 100. The phone 100 may be connected to an external device by using an external connection device, such as a sub-communication module 130, a connector 165, and an earphone connecting jack 167. The “external device” may include a variety of devices, such as earphones, external speakers, Universal Serial Bus (USB) memories, chargers, cradles/docks, Digital Multimedia Broadcasting (DMB) antennas, electronic payment related devices, health care devices (for example, blood sugar testers), game consoles, vehicle navigations, a cellphone, a smart phone, a tablet PC, a desktop PC, a server, and the like, which are removable from the electronic device and connected thereto via a cable.

The phone 100 includes a touch screen display 190 and a touch screen controller 195. The phone 100 also includes a controller 110, a mobile communication module 120, the sub-communication module 130, a multimedia module 140, a camera module 150, a Global Positioning System (GPS) module 155, an input/output module 160, a sensor module 170, a memory 175, and a power supply 180. The sub-communication module 130 includes at least one of Wireless Local Area Network (WLAN) 131 and a short-range communication module 132, and the multimedia module 140 includes at least one of a broadcast communication module 141, an audio play module 142, and a video play module 143. The input/output module 160 includes at least one of buttons 161, a microphone 162, a speaker 163, a vibration motor 164, the connector 165, and a keypad 166. Additionally, the electronic device 100 may include one or more lights including a first light 153 that faces one direction and a second light 154 that faces another direction.

The controller 110 may include a Central Processing Unit (CPU) 111, a Read Only Memory (ROM) 112 for storing a control program, such as an Operating System (OS), to control the phone 100, and a Random Access Memory (RAM) 113 for storing signals or data input from an external source or for being used as a memory space for working results in the phone 100. The CPU 111 may include a single core, dual cores, triple cores, or quad cores. The CPU 111, ROM 112, and RAM 113 may be connected to each other via an internal bus.

The controller 110 may control the mobile communication module 120, the sub-communication module 130, the multimedia module 140, the camera module 150, the GPS module 155, the input/output module 160, the sensor module 170, the memory 175, the power supply 180, the touch screen display 190, and the touch screen controller 195. The mobile communication module 120 connects the electronic device 100 to an external device through mobile communication using at least a one-to-one antenna or a one-to-many antenna under the control of the controller 110. The mobile communication module 120 transmits/receives wireless signals for voice calls, video conference calls, Short Message Service (SMS) messages, or Multimedia Message Service (MIMS) messages to/from a cell phone, a smart phone, a tablet PC, or another device, with the phones having phone numbers entered into the phone 100.

The sub-communication module 130 may include at least one of the WLAN module 131 and the short-range communication module 132. For example, the sub-communication module 130 may include either the WLAN module 131 or the-short range communication module 132, or both. The WLAN module 131 may be connected to the Internet in a place where there is a wireless Access Point (AP), under the control of the controller 110. The WLAN module 131 supports the WLAN Institute of Electrical and Electronic Engineers (IEEE) 802.11x standard. The short-range communication module 132 may conduct short-range communication between the phone 100 and an image rendering device under the control of the controller 110. The short-range communication may include communications compatible with BLUETOOTH™, a short range wireless communications technology at the 2.4 GHz band, commercially available from the BLUETOOTH SPECIAL INTEREST GROUP, INC., Infrared Data Association (IrDA), WI-FI™ DIRECT, a wireless technology for data exchange over a computer network, commercially available from the WI-FI ALLIANCE, NFC, and the like.

The phone 100 may include at least one of the mobile communication module 120, the WLAN module 131, and the short-range communication module 132 based on the performance requirements of the phone 100. For example, the phone 100 may include a combination of the mobile communication module 120, the WLAN module 131, and the short-range communication module 132 based on the performance requirements of the phone 100. The multimedia module 140 may include the broadcast communication module 141, the audio play module 142, or the video play module 143. The broadcast communication module 141 may receive broadcast signals (for example, television broadcast signals, radio broadcast signals, or data broadcast signals) and additional broadcast information (for example, an Electric Program Guide (EPG) or an Electric Service Guide (ESG)) transmitted from a broadcasting station through a broadcast communication antenna under the control of the controller 110. The audio play module 142 may play digital audio files (for example, files having extensions, such as mp3, wma, ogg, or way) stored or received under the control of the controller 110. The video play module 143 may play digital video files (for example, files having extensions, such as mpeg, mpg, mp4, avi, move, or mkv) stored or received under the control of the controller 110. The video play module 143 may also play digital audio files.

The multimedia module 140 may include the audio play module 142 and the video play module 143 except for the broadcast communication module 141. The audio play module 142 or video play module 143 of the multimedia module 140 may be included in the controller 110. The camera module 150 may include one or more cameras for capturing still images or video images under the control of the controller 110. Furthermore, the one or more cameras may include an auxiliary light source (for example, a flash) for providing an amount of light for capturing an image. In one example, one or more cameras may be placed on the front of the phone 100, and one or more other cameras may be placed on the back of phone 100. Two or more cameras may be arranged, in some implementations, adjacent to each other (for example, the distance between the two or more cameras, respectively, may be in the range of 1 cm. to 8 cm.), capturing 3 Dimensional (3D) still images or 3D video images.

The GPS module 155 receives radio signals from a plurality of GPS satellites in orbit around the Earth and may calculate the position of the phone 100 by using time of arrival from the GPS satellites to the phone 100. The input/output module 160 may include at least one of the plurality of buttons 161, the microphone 162, the speaker 163, the vibrating motor 164, the connector 165, and the keypad 166. The at least one of the buttons 161 may be arranged on the front, side or back of the housing of the phone 100, and may include at least one of a power/lock button, a volume button, a menu button, a home button, a back button, and a search button. The microphone 162 generates electric signals by receiving voice or sound under the control of the controller 110.

The speaker 163 may output sounds externally corresponding to various signals (for example, radio signals, broadcast signals, digital audio files, digital video files or photography signals) from the mobile communication module 120, sub-communication module 130, multimedia module 140, or camera module 150 under the control of the controller 110. The speaker 163 may output sounds (for example, button-press sounds or ringback tones) that correspond to functions performed by the electronic device 100. There may be one or multiple speakers 163 arranged in at least one position on or in the housing of the phone 100.

The vibrating motor 164 may convert an electric signal to a mechanical vibration under the control of the controller 110. For example, the phone 100 in a vibrating mode operates the vibrating motor 164 when receiving a voice call from another device. There may be at least one vibration motor 164 inside the housing of the phone 100. The vibration motor 164 may operate in response to a touch activity or continuous touches of a user over the touch screen display 190.

The connector 165 may be used as an interface for connecting the phone 100 to the external device or a power source. Under the control of the controller 110, the phone 100 may transmit data stored in the memory 175 of the electronic device 100 to the external device via a cable connected to the connector 165, or receive data from the external device. Furthermore, the phone 100 may be powered by the power source via a cable connected to the connector 165 or may charge the battery using the power source.

The keypad 166 may receive key inputs from the user to control the phone 100. The keypad 166 includes a mechanical keypad formed in the phone 100, or a virtual keypad displayed on the touch screen display 190. The mechanical keypad formed in the phone 100 may optionally be omitted from the implementation of the phone 100, depending on the performance requirements or structure of the phone 100. An earphone may be inserted into the earphone connecting jack 167 and thus, may be connected to the phone 100. A stylus pen 168 may be inserted and removably retained in the phone 100 and may be drawn out and detached from the phone 100.

A pen-removable recognition switch 169 that operates in response to attachment and detachment of the stylus pen 168 is equipped in an area inside the phone 100 where the stylus pen 168 is removably retained, and sends a signal that corresponds to the attachment or the detachment of the stylus pen 168 to the controller 110. The pen-removable recognition switch 169 may have a direct or indirect contact with the stylus pen 168 when the stylus pen 168 is inserted into the area. The pen-removable recognition switch 169 generates the signal that corresponds to the attachment or detachment of the stylus pen 168 based on the direct or indirect contact and provides the signal to the controller 110.

The sensor module 170 includes at least one sensor for detecting a status of the phone 100. For example, the sensor module 170 may include a proximity sensor for detecting proximity of a user to the phone 100, an illumination sensor for detecting an amount of ambient light of the electronic device 100, a motion sensor for detecting the motion of the phone 100 (for example, rotation of the phone 100, acceleration or vibration applied to the phone 100), a geomagnetic sensor for detecting a point of the compass using the geomagnetic field, a gravity sensor for detecting a direction of gravity, and an altimeter for detecting an altitude by measuring atmospheric pressure. At least one sensor may detect the status and generate a corresponding signal to transmit to the controller 110. The sensor of the sensor module 170 may be added or removed depending on the performance requirements of the phone 100.

The memory 175 may store signals or data input/output according to operations of the mobile communication module 120, the sub-communication module 130, the multimedia module 140, the camera module 150, the GPS module, the input/output module 160, the sensor module 170, the touch screen display 190 under the control of the controller 110. The memory 175 may store the control programs and applications for controlling the phone 100 or the controller 110.

The term “storage” may refer to the memory 175, and also to the ROM 112, RAM 113 in the controller 110, or a memory card (for example, a Secure Digital (SD) card, a memory stick, and the like) installed in the phone 100. The storage may also include a non-volatile memory, a volatile memory, a Hard Disc Drive (HDD), a Solid State Drive (SSD), and the like.

The power supply 180 may supply power from at least one battery placed inside the housing of the phone 100 under the control of the controller 110. The at least one battery may thus power the phone 100. The power supply 180 may supply the phone 100 with the power input from the external power source via a cable connected to the connector 165. The power supply 180 may also supply the phone 100 with wireless power from an external power source using a wireless charging technology.

The touch screen controller 195 receives information (for example, information to be generated for making calls, data transmission, broadcast, or photography) that is processed by the controller 110, converts the information to data to be displayed on the touch screen display 190, and provides the data to the touch screen display 190. The touch screen display 190 displays the data received from the touch screen controller 195. For example, in a call mode, the touch screen display 190 may display a User Interface (UI) or a Graphic User Interface (GUI) with respect to a call. The touch screen display 190 may include at least one of liquid crystal displays, thin film transistor-liquid crystal displays, organic light-emitting diodes, flexible displays, 3D displays (for instance, for presenting 3D images as described herein), multi-view displays, electrophoretic displays, or combinations of the same and the like. The touch screen display 190 moreover may be used to present video images as described herein, such as including 2D video images, 3D video images, and 2D/3D virtual reality (VR), augmented reality (AR), and mixed reality (MR). In some implementations, the phone 100 further includes a holographic module that processes and outputs holographic video images for presentation, such as on the touch screen display 190 or another display of the phone 100.

The touch screen display 190 may be used as an output device and also as an input device, and for the latter case, may have a touchscreen panel to operate as a touch screen. The touch screen display 190 may send to the touch screen controller 195 an analog signal that corresponds to at least one touch to the UI or GUI. The touch screen display 190 may detect the at least one touch by a user's physical contact (for example, by fingers including a thumb) or by a touchable input device (for example, the stylus pen). The touch screen display 190 may also receive a dragging movement of a touch among at least one touch and transmit an analog signal that corresponds to the dragging movement to the touch screen controller 195. The touch screen display 190 may be implemented to detect at least one touch in, for example, a resistive method, a capacitive method, an infrared method, an acoustic wave method, and the like.

The term “touches” is not limited to physical touches by a physical contact of the user or contacts with the touchable input device, but may also include touchless proximity (for example, maintaining a detectable distance less than 1 mm. between the touch screen display 190 and the user's body or touchable input device). The detectable distance from the touch screen display 190 may vary depending on the performance requirements of the phone 100 or structure of the phone 100, and more particularly, the touch screen display 190 may output different values (for example, current values) for touch detection and hovering detection to distinguishably detect that a touch event occurred by a contact with the user's body or the touchable input device and a contactless input (for example, a hovering event). Furthermore, the touch screen display 190 may output different values (for example, current values) for hovering detection over distance from where the hovering event occurs.

The touch screen controller 195 converts the analog signal received from the touch screen display 190 to a digital signal (for example, in XY coordinates on the touch panel or display screen) and transmits the digital signal to the controller 110. The controller 110 may control the touch screen display 190 by using the digital signal received from the touch screen controller 195. For example, in response to the touch event or the hovering event, the controller 110 may enable a shortcut icon displayed on the touch screen display 190 to be selected or to be executed. The touch screen controller 195 may also be incorporated in the controller 110.

Further, the touch screen controller 195 may determine the distance between where the hovering event occurs and the touch screen display 190 by detecting a value (for example, a current value) output through the touch screen display 190, convert the determined distance to a digital signal (for example, with a Z coordinate), and provide the digital signal to the controller 110.

One of more of the components or modules of the phone 100 may be removably coupled to a housing of the phone 100. To help illustrate this coupling, the housing of the phone 100 may be understood to be the phone 10, while the one of more of the components or modules may be removably coupled to the phone 10 via the module connector 20 to add or remove functionality for the phone 10. As one example, a portion or all of the camera module 30 may be removably coupled to the phone 10 to provide the phone 10 with the functionality of part or all the camera module 30.

While certain electronic devices shown and described herein are cellphones, other handheld electronic device embodiments are not cellphones, and do not include telephonic capability. For instance, some embodiments have the same or similar exterior as the electronic devices described herein, but do not include telephonic capability, such as in the case of a tablet computing device or digital camera. Such embodiments may nonetheless include any combination of the non-telephone components and functionality described herein, such as one or more of the following or portions thereof: controller 110, touch screen display 190 and touch screen controller 195, camera module 150, multi-media module 140, sub-communication module 130, first light 153, second light 154, GPS module 155, I/O module 160, and memory 176.

The various image capture devices (or certain components of the devices) may be described herein as being “configured to” perform one or more functions. As used herein this means that the device is capable of being placed in at least one mode (for example, user selectable modes) in which the device performs the specified functions. For example, the device may not necessarily perform the specified functions in all of the operational modes. Along these lines, use of the phrase “configured to” does not imply that the device has to actually be currently placed in the operational mode to be “configured to” perform the function, but only that the device is capable of being (for example, programmed to be) selectively placed into that mode.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor may be a microprocessor, or, any processor, controller, microcontroller, or state machine. A processor also may be implemented as a combination of electronic devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, for example, one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that may be enabled to transfer a computer program from one place to another. Storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “can,” “for example,” “for example,” “such as” and the like, unless specifically stated otherwise, or otherwise understood within the context as used, is generally intended to convey that certain embodiments include, while other embodiments do not include, certain features, elements or states. Thus, such conditional language is not generally intended to imply that features, elements or states are in any way required for one or more embodiments or that one or more embodiments necessarily include logic for deciding, with or without author input or prompting, whether these features, elements or states are included or are to be performed in any particular embodiment.

The above detailed description of embodiments is not intended to be exhaustive or to be limiting to the precise form disclosed above. While specific embodiments and examples are described above for illustrative purposes, various equivalent modifications are possible within the scope of the inventions described herein, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, or modified. Each of these processes or blocks may be implemented in a variety of different ways. Also, while processes or blocks are at times shown as being performed in series, these processes or blocks may instead be performed in parallel, or may be performed at different times.

The teachings provided herein may be applied to other systems, not only the systems described above. The elements and acts of the various embodiments described above may be combined to provide further embodiments.

The disclosed subject matter has been provided here with reference to one or more features or embodiments. Those skilled in the art will recognize and appreciate that, despite of the detailed nature of the example embodiments provided here, changes and modifications may be applied to said embodiments without limiting or departing from the generally intended scope. These and various other adaptations and combinations of the embodiments provided here are within the scope of the disclosed subject matter as defined by the disclosed elements and features and their full set of equivalents.

A portion of the disclosure of this patent document may contain material, which is subject to copyright protection. The owner has no objection to facsimile reproduction by any one of the patent documents or the patent disclosure, as it appears in the Patent and Trademark Office patent files or records, but reserves all copyrights whatsoever. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

What is claimed is:

1. An mobile device comprising:
a housing;
at least two cameras supported by the housing and arranged to capture image data; and
a multi-view display.

2. The mobile device of claim 1, wherein the multi-view display is a lightfield display.

3. The mobile device of claim 1, wherein the multi-view display comprises a diffractive lightfield backlighting system.

4. The mobile device of claim 1, wherein the multi-view display is configured to display multi-view video derived from image data captured by the at least two cameras.

5. The mobile device of claim 1, wherein the multi-view display is configured to operate in at least one of a multi-view mode or a multi-dimensional display mode.

6. The mobile device of claim 5, wherein the multi-dimensional display mode comprises a two-dimensional display mode and a three-dimensional display mode.

7. The mobile device of claim 1, wherein the at least two cameras are configured to capture stereoscopic image data.

8. The mobile device of claim 1, wherein the multi-view display is configurable to operate in a playback mode to play multi-view video previously recorded.

9. The mobile device of claim 1, wherein the multi-view display is configurable to operate as a viewfinder to present multi-view video in real time.

10. The mobile device of claim 1 further comprising a module connector for connecting at least a first functional module to the mobile device to enhance image capture or display functionalities of the mobile device.

11. An mobile device comprising:
a housing;
at least two cameras supported by the housing and arranged to capture image data; and
a processor for processing one or more audio spatialization profiles to generate multi-dimensional audio.

12. The mobile device of claim 11, wherein the processor is configured to apply at least one spatialization profile of the one or more spatialization profiles to an audio signal to generate a spatialized audio signal.

13. The mobile device of claim 12, wherein the spatialization profile comprises one or more impulse responses.

14. The mobile device of claim 13, wherein the processor is configured to convolve the audio signal with the one or more impulse responses to generate the spatialized audio signal.

15. The mobile device of claim 13, wherein application of the spatialization profile to the audio signal results in one or both of a directional audio effect or an externalization audio effect when the spatialized audio signal is played.

16. The mobile device of claim 14, wherein at least two speakers configured to output the spatialized audio signal.

17. The mobile device of claim 15, wherein the processor applies the spatialization profile when the mobile device is in a landscape orientation.

18. The mobile device of claim 15, wherein the processor fails to apply the spatialization profile when the mobile device is in a portrait orientation.

19. The mobile device of any of claim 16, wherein the at least two speakers comprise a first speaker positioned on a top half of the housing and a second speaker positioned on a bottom half of the housing.

20. The mobile device of claim 19, wherein the first speaker and the second speaker are positioned substantially symmetrically with respect to one another on opposing sides of a transverse axis of the mobile device.

21. An mobile device comprising:
a housing;
at least two cameras supported by the housing and arranged to capture image data;
a multi-view display comprising diffractive lightfield backlighting system configured to display multi-view video derived from image data captured by the at least two cameras; and
a processor for processing one or more audio spatialization profiles for applying at least one spatialization profile of the one or more spatialization profiles to an audio signal to generate a spatialized audio signal, wherein the spatialization profile comprises one or more impulse responses.

22. The mobile device of claim 21, wherein the multi-view display is configured to operate in at least one of a multi-view mode or a multi-dimensional display mode comprising a two-dimensional display mode and a three-dimensional display mode.

23. The mobile device of claim 21, wherein the processor is configured to convolve the audio signal with the one or more impulse responses to generate the spatialized audio signal, such that application of the spatialization profile to the audio signal results in one or both of a directional audio effect or an externalization audio effect when the spatialized audio signal is played.

24. The mobile device of claim 22, wherein the at least two cameras are configured to capture stereoscopic image data and at least two speakers are configured to output the spatialized audio signal.

25. The mobile device of claim 24, wherein the processor applies the spatialization profile when the mobile device is in a landscape orientation and fails to apply the spatialization profile when the mobile device is in a portrait orientation.

26. The mobile device of claim 21 further comprising a module connector for connecting one or more functional modules attachable to the housing, a functional module configured for enhancing one of video or audio functionalities of the mobile device.

27. The mobile device of claim 26, wherein the module connector comprises data communication bus contacts corresponding to at least a first data bus and a second data bus, wherein the bus contacts for the first data bus are adjacent to either a ground pin or another bus contact for the first data bus and each of the bus contacts for the second data bus are adjacent either to a ground contact or to another contact corresponding to the second data bus.

28. The mobile device of claim 26, wherein the module connector comprises a module identifier contact, the mobile device further comprising circuitry configured, when the module identifier contact is coupled to a corresponding contact of a module attached to the mobile device, to detect a value of a resistor connected to the corresponding contact.

29. The mobile device of claim 28 comprising a camera module attachable to the housing of the mobile device via the module connector.

30. The mobile device of claim 29, wherein the camera module comprises:
a battery which, when the camera module and the housing of the mobile device are attached, powers electronics within the mobile device; and
an image processing componentry configured to generate compressed raw video data.
